(19) United States
(12) Patent Application Publication
(10) Pub. No.: US 2018/0352572 A1
(43) Pub. Date: Dec. 6, 2018

(54) ACCESS CATEGORIES AND ENHANCED DISTRIBUTED CHANNEL ACCESS FUNCTION (EDCAF) FOR TRIGGER FRAMES

(71) Applicant: Intel IP Corporation, Santa Clara, CA (US)

(72) Inventors: Laurent Cariou, Portland, OR (US); Yaron Alpert, Hod Hasharoni (IL); Chittabrata Ghosh, Fremont, CA (US); Po-Kai Huang, San Jose, CA (US); Robert J. Stacey, Portland, OR (US)

(73) Assignee: Intel IP Corporation, Santa Clara, CA (US)

(21) Appl. No.: 15/769,429

(22) PCT Filed: Jun. 30, 2016
(86) PCT No.: PCT/US16/40440

§ 371 Date: Apr. 19, 2018

Related U.S. Application Data
(60) Provisional application No. 62/244,296, filed on Oct. 21, 2015.
(60) Provisional application No. 62/313,510, filed on Mar. 25, 2016.

(51) Int. Cl. H04W 74/08

(52) U.S. Cl. CPC H04W 74/085; H04W 84/12

(57) ABSTRACT

Apparatuses, methods, and computer readable medium for access categories (ACs) and enhanced distributed channel access functions for trigger frames are disclosed. An apparatus of a wireless device is disclosed. The apparatus comprises processing circuitry configured to contend for access to a wireless medium of a channel with a first access category (AC), where the first AC comprises a first transmission opportunity (TXOP) limit, a first contention window minimum (CWmin), a first contention window maximum (CWmax), and a first arbitration inter-frame space (AIFS) number (AIFSN), and where the wireless device is to contend for the wireless medium in accordance with the first CWmin, the first CWmax, and the first AIFSN. The processing circuitry configured to transmit a trigger frame with a second AC to the stations, where the trigger frame is to start a TXOP with the first TXOP limit, when access to the channel is gained with the first AC.

### PRIORITY CLAIM

This application claims the benefit of priority to U.S. Provisional Patent Application Ser. No. 62/244,296, filed Oct. 21, 2015, and U.S. Provisional Patent Application Ser. No. 62/313,510, filed Mar. 25, 2016, both of which are incorporated herein by reference in its entirety.

### TECHNICAL FIELD

Embodiments pertain to wireless networks and wireless communications. Some embodiments relate to wireless local area networks (WLANs) and Wi-Fi networks including networks operating in accordance with the IEEE 802.11 family of standards. Sonic embodiments relate to IEEE 802.11ax. Some embodiments relate to methods, computer readable media, and apparatus for access categories and enhanced distributed channel access function (EDCAF) for trigger frames. Some embodiments relate to methods, computer readable media, and apparatus for EDCAF for master stations for stations.

### BACKGROUND

Efficient use of the resources of a wireless local-area network (WLAN) is important to provide bandwidth and acceptable response times to the users of the WLAN. However, often there are many devices trying to share the same resources and some devices may be limited by the communication protocol they use or by their hardware bandwidth. Moreover, wireless devices may need to operate with both newer protocols and with legacy device protocols.

### BRIEF DESCRIPTION OF THE DRAWINGS

The present disclosure is illustrated by way of example and not limitation in the figures of the accompanying drawings, in which like references indicate similar elements and in which:

FIG. 1 illustrates a WLAN in accordance with some embodiments;

FIG. 2 illustrates channel access priorities in accordance with some embodiments;

FIG. 3 illustrates a method for access categories for trigger frames and EDCAF for master stations in accordance with some embodiments;

FIG. 4 illustrates EDCAF parameters in accordance with some embodiments;

FIG. 5 illustrates a method for access categories for trigger frames and EDCAF for master stations in accordance with some embodiments;

FIG. 6 illustrates a method for access categories for trigger frames and EDCAF for master stations in accordance with some embodiments;

FIG. 7 illustrates a method for access categories for trigger frames and EDCAF for master stations in accordance with some embodiments;

FIG. 8 illustrates a method for access categories for trigger frames and EDCAF for master stations in accordance with some embodiments;

FIG. 9 illustrates a method for access categories for trigger frames and EDCAF for master stations in accordance with some embodiments;

FIG. 10 illustrates a method for access categories for trigger frames and EDCAF for master stations in accordance with some embodiments;

FIG. 11 illustrates a method for access categories for trigger frames and EDCAF for master stations in accordance with some embodiments;

FIG. 12 illustrates a method for access categories for trigger frames and EDCAF for master stations in accordance with some embodiments;

FIG. 13 illustrates a simulation with a legacy BSS and HE BSS in accordance with some embodiments;

FIG. 14 illustrates a simulation with legacy devices and HE devices in accordance with some embodiments;

FIG. 15 illustrates a access categories for EDCAF in accordance with some embodiments;

FIG. 16 illustrates a block diagram of an example of EDCAF for AP access for UL MU transmission in accordance with some embodiments;

FIG. 17 illustrates a block diagram of an example of EDCAF for AP access for UL MU transmission in accordance with some embodiments;

FIG. 18 illustrates a method of EDCAF for AP access for UL multi-user (MU) transmission in accordance with some embodiments;

FIG. 19 illustrates a method of EDCAF for AP access for UL multi-user (MU) transmission in accordance with some embodiments; and

FIG. 20 illustrates a block diagram of an example machine upon which any one or more of the techniques (e.g., methodologies) discussed herein may perform, in accordance with some embodiments.

### DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

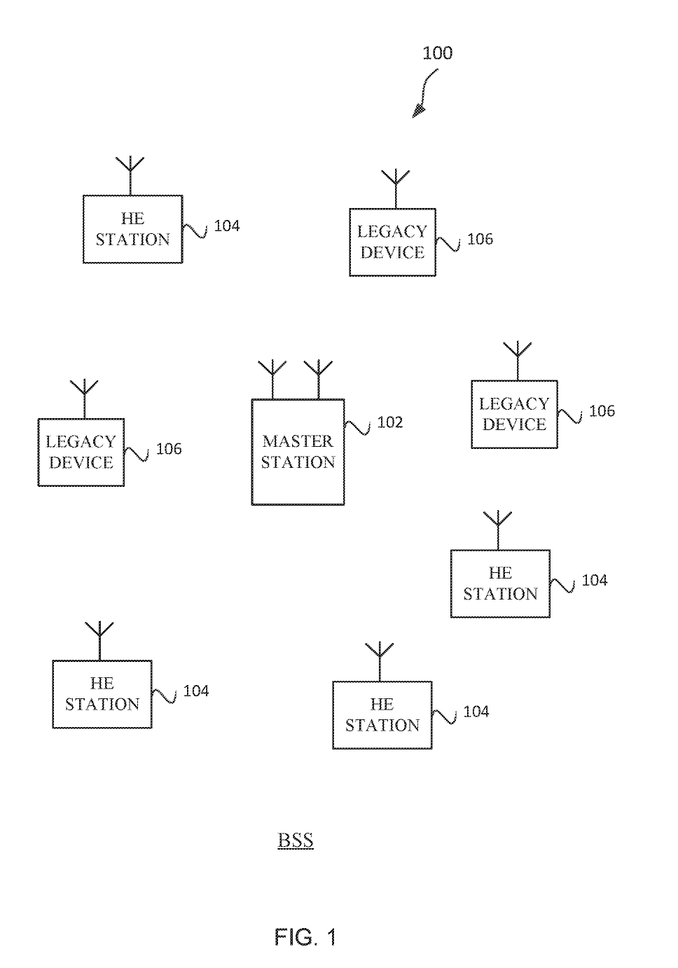

FIG. 1 illustrates a WLAN 100 in accordance with some embodiments. The WLAN may comprise a basis service set (BSS) 100 that may include a master station 102, which may be an AP, a plurality of high-efficiency (HE) (e.g., IEEE 802.11ax) stations 104, and a plurality of legacy (e.g., IEEE 802.11n/ac) devices 106.

The master station 102 may be an AP using one of the IEEE 802.11 protocols to transmit and receive. The master station 102 may be a base station. The master station 102 may use other communications protocols as well as the IEEE 802.11 protocol. The IEEE 802.11 protocol may be IEEE 802.11ax. The IEEE 802.11 protocol may include using orthogonal frequency division multiple-access (OFDMA), time division multiple access (TDMA), and/or code division multiple access (CDMA). The IEEE 802.11 protocol may include a multiple access technique. For example, the IEEE 802.11 protocol may include space-division multiple access (SDMA) and/or multiple-user multiple-input multiple-output (MU-MEMO). The master station 102 and/or HE station 104 may use one or both of MU-MIMO and OFDMA. There may be more than one master station 102 that is part of an extended service set (ESS). A controller (not illustrated) may store information that is common to the more than one master station 102. The controller may have access to an external network such as the Internet.

The legacy devices 106 may operate in accordance with one or more of IEEE 802.11 a/b/g/n/ac/ad/af/ah/aj, or another legacy wireless communication standard. The legacy devices 106 may be STAs or IEEE 802.11 STAs. The HE stations 104 may be wireless transmit and receive devices such as cellular telephone, smart telephone, handheld wireless device, wireless glasses, wireless watch, wireless personal device, tablet, or another device that may be transmitting and receiving using the IEEE 802.11 protocol such as IEEE 802.11ax or another wireless protocol such as IEEE 802.11az. In some embodiments, the HE stations 104, master station 102, and/or legacy devices 106 may be termed wireless devices. In some embodiments the HE station 104 may be a “group owner” (GO) for peer-to-peer modes of operation where the HE station 104 may perform some operations of a master station 102.

The master station 102 may communicate with legacy devices 106 in accordance with legacy IEEE 802.11 communication techniques. In example embodiments, the master station 102 may also be configured to communicate with HE stations 104 in accordance with legacy IEEE 802.11 communication techniques.

In some embodiments, a HE frame may be configurable to have the same bandwidth as a channel. The bandwidth of a channel may be 20 MHz, 40 MHz, or 80 MHz 160 MHz, 320 MHz contiguous bandwidths or an 80+80 MHz (160 MHz) non-contiguous bandwidth. In some embodiments, the bandwidth of a channel may be 1 MHz, 1.25 MHz, 2.03 MHz, 2.5 MHz, 5 MHz and 10 MHz, or a combination thereof or another bandwidth that is less or equal to the available bandwidth may also be used. In some embodiments the bandwidth of the channels may be based on a number of active subcarriers. In some embodiments the bandwidth of the channels are multiples of 26 (e.g., 26, 52, 104, etc.) active subcarriers or tones that are spaced by 20 MHz. In some embodiments the bandwidth of the channels are 26, 52, 104, 242, etc. active data subcarriers or tones that are space 20 MHz apart. In some embodiments the bandwidth of the channels is 256 tones spaced by 20 MHz. In some embodiments a 20 MHz channel may comprise 256 tones for a 256 point Fast Fourier Transform (FFT). In some embodiments, a different number of tones is used. In some embodiments, the OFDMA structure consists of a 26-subcarrier resource unit (RU), 52-subcarrier RU, 106-subcarrier RU, 242-subcarrier RU, 484-subcarrier RU and 996-subcarrier RU. Resource allocations for single user (SU) consist of a 242 subcarrier RU, 484-subcarrier RU, 996-subcarrier RU and 2x996-subcarrier RU.

A HE frame may be configured for transmitting a number of spatial streams, which may be in accordance with MU-MIMO. In some embodiments, a HE frame may be configured for transmitting in accordance with one or both of OFDMA and MU-MIMO. In other embodiments, the master station 102, HE station 104, and/or legacy device 106 may also implement different technologies such as code division multiple access (CDMA) 2000, CDMA 2000 1X, CDMA 2000 Evolution-Data Optimized (EV-DO), Interim Standard 2000 (IS-2000), Interim Standard 95 (IS-95). Interim Standard 856 (IS-856), Long Term Evolution (LTE), Global System for Mobile communications (GSM), Enhanced Data rates for GSM Evolution (EDGE), GSM EDGE (GERAN), IEEE 802.16 (i.e., Worldwide Interoperability for Microwave Access (WiMAX)), BlueTooth®, WiMAX, WiGig, or other technologies.

Some embodiments relate to HE communications. In accordance with some IEEE 802.11ax embodiments, a master station 102 may operate as a master station which may be arranged to contend for a wireless medium (e.g., during a contention period) to receive exclusive control of the medium for an HE control period. In some embodiments, the HE control period may be termed a transmission opportunity (TXOP). The master station 102 may transmit a FIE master-sync transmission, which may be a trigger frame or HE control and schedule transmission, at the beginning of the HE control period. The master station 102 may transmit a time duration of the TXOP and channel information. During the HE control period, HE stations 104 may communicate with the master station 102 in accordance with a non-contention based multiple access technique such as OFDMA and/or MU-MIMO. This is unlike conventional WLAN communications in which devices communicate in accordance with a contention-based communication technique, rather than a multiple access technique. During the HE control period, the master station 102 may communicate with HE stations 104 using one or more HE frames. During the HE control period, the HE STAs 104 may operate on a channel smaller than the operating range of the master station 102. During the HE control period, legacy stations refrain from communicating.

In accordance with some embodiments, during the master-sync transmission the HE STAs 104 may contend for the wireless medium with the legacy devices 106 being excluded from contending for the wireless medium during the master-sync transmission or TXOP. In some embodiments the trigger frame may indicate an uplink (UL) UL-MU-MIMO and/or UL OFDMA control period. In some embodiments, the trigger frame may indicate a portions of the TXOP that are contention based for some HE station 104 and portions that are not contention based.

In some embodiments, the multiple-access technique used during the HE control period may be a scheduled OFDMA technique, although this is not a requirement. In some embodiments, the multiple access technique may be a time-division multiple access (TDMA) technique or a frequency division multiple access (FDMA) technique. In some embodiments, the multiple access technique may be a space-division multiple access (SDMA) technique,

In example embodiments, the HE device 104 and/or the master station 102 are configured to perform the methods and operations herein described in conjunction with FIGS. 1-20.

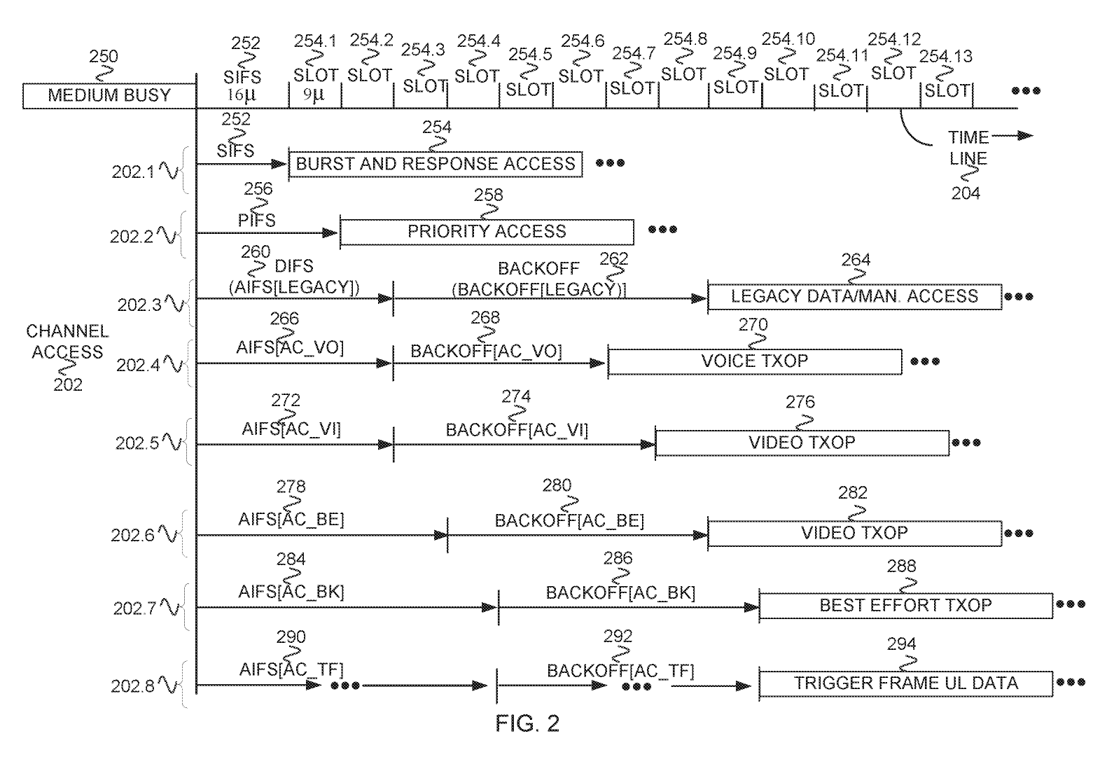

FIG. 2 illustrates channel access priorities in accordance with some embodiments. Illustrated in FIG. 2 is time line 204 along a horizontal axis and channel access 202 along a vertical axis. Channel access 202 refers to the methods used by wireless devices to determine that the wireless device may transmit on the wireless medium of a channel. A channel may be a channel as described herein, e.g. less 20 MHz, 20 MHz, 40 MHz, etc. The time line 204 begins with medium busy 250. Wireless medium busy 250 indicates that a wireless medium is busy which may be determined by a wireless device's virtual carrier sensing such as a network allocation vector (NAV) or an actual physical carrier sensing of the wireless medium such as energy detect or preamble detect with frame length deferral to determine if the wireless medium is busy.

The time line 204 continues with short inter-frame space (SIRS) 252, which may have a duration of 16 μs in some embodiments. SIFS 252 may be a time that is sufficient for a wireless device to respond to another frame to begin. The duration of SIFS 252 may be different than 16 μs and may be in accordance with one or more wireless communication standards. The time line 204 continues with a number of slots 254 which may be 9 μs in some embodiments. The slots 254 indicate time increments that the wireless devices may use. Wireless devices may synchronize on boundaries of the slots 254. The duration of slots 254 may be a different than 9 μs and may be in accordance with one or more wireless communication standards. In some embodiments, a wireless device may be a legacy devices 106, HE station 104, and/or master station 102.

A wireless device may use the methods of channel access 202 to access a channel. The channel access 202 methods may be used by wireless devices in different situations and in accordance with different wireless communication standards as described herein. The channel access 202 methods may be methods for after the wireless device has determined that the wireless medium is not idle, i.e. medium busy 250. In some embodiments, if the wireless device would like to transmit a frame and the wireless device determines that the wireless medium is idle for a duration, e.g., distributed coordination function (DCF) inter-frame space (DIFS) 260, then the wireless device may transmit the frame.

Table 1 illustrates enhanced distributed channel access (EDCA) access parameters for different access categories (ACs). The EDCA access parameters are used by a wireless device to perform methods to access the medium of a channel, e.g., channel access 202.

TABLE 1
EDCA ACCESS PARAMETERS

| AC | CWmin | CWmax | AIFSN | TXOP Limit |
|---|---|---|---|---|
| AC_BK | 31 | 1023 | 7 | 0 |
| AC_BE | 31 | 1023 | 3 | 0 |
| AC_VI | 15 | 31 | 2 | 3.008 ms |
| AC_VO | 7 | 15 | 2 | 1.504 ms |
| legacy | 15 | 1023 | 2 | 0 |
| AC_TF | A | B | C | D |

The ACs provides different parameters that represent different levels of priority for accessing the medium of the channel. As illustrated there are six ACs. AC for background (AC_BK). AC best effort (AC_BE). AC video (AC_VI). AC for voice (AC_VO). Legacy for an AC for legacy devices (e.g., legacy devices 106). AC for trigger frames (AC_TF). The EDCA access parameters are contention window (CW) minimum (CWmin), CW maximum (CWmax), arbitration inter-frame space (AIFS) number (AIFSN), and transmission opportunity (TXOP) limit. The EDCA access parameters are used to determine how the wireless devices access the wireless medium for channel access 202.3 through 202.8.

The CWmin[AC_TF], CWinax[AC_TF], AIFSN[AC_TF] and TXOP limit [AC_TF] may be parameters A, B, C, and D, which have values in accordance with embodiments described herein. In some embodiments, a master station 102 may configure the AC_TF parameters A, B, C, and D, for CWmin, CWmax, AIFSN, and TXOP limit, respectively. The master station 102 may configure A, B, C, and D based on current traffic conditions and/or current UL and DL data needs. In some embodiments there may be a default values for CWmin[AC_TF], CW[AC_TF], AIFSN[AC_TF], and TXOP_Limit[AC_TF].

For channel access 202.3 through 202.8, the wireless device accesses the medium of a channel as follows if the medium is determined to be busy (e.g., medium busy 250) when the wireless device first attempts to access the medium to transmit a frame. The wireless device determines a backoff time in accordance with an AC. The backoff time for EDCA devices may be backoff[AC]. Backoff time may be in terms of a number of slots 254. The backoff may be selected as a random count in the range of 0 to CWmin[AC] (from Table 1). For example, for legacy backoff may be a random count from 0 to CWmin[legacy]=15, e.g., a whole number of slots 254 between 0 and 15.

The wireless device waits an AIFS for the medium to be idle and then decreases the backoff for each slat 254 that the medium is idle. When the backoff decreases to zero, the wireless device transmits the frame. For example, voice TXOP 270. The AIFS may be determined as follows: AIFS[AC]aSIFSTime+AIFSN[AC]×aSlotTime, where aSIFSTime is the duration of a SIFS 252 (e.g., 16 μs); AIFSN[AC] is AIFS number (AIFSN)(see Table 1 where, e.g., AIFSN[legacy] is a number 2); and, aSlotTime is a duration of a slot 254 (e.g., 9 μs). For example, AIFS[legacy] is 16 μs (SIFS 252)+2 (AIFSN[legacy]=2)×9 μs (aSlotTime=slot 254)=34 μs. Channel access 202.2 illustrates legacy access. Distributed channel function (DCF) inter-frame space (DIES) 260 is 34 μs. DIFS 260 is a legacy term that for channel access 202 may also be termed AIFSN[legacy] where the AIFS parameters were chosen to match the legacy method. As another example, AIFS[AC_BE] 278=16 μs (SIFS 252)+3 (AIFSN[BE]=3)×9 μs (aSlotTime=slot 254)=43 μs. AIFS[AC_BE] 278 goes up to slot 254.3, which is 3×9 μs+16 μs=43 μs, which agrees with the above determination.

If the wireless device, transmits the frame e.g., 264, 270, 276, 282, 288, and 294), and the transmission is not successful (e.g., no response is received or the wireless device detects a collision with another frame), then the wireless device doubles the backoff and tries the channel access 202 method again. The backoff is doubled up to CWmax[AC] at which time it stays at CWmax[AC]. If the wireless device detects that the wireless medium is busy during the backoff 262, 268, 274, 280, 286, and 292, then the wireless device defers until the wireless medium is idle (including NAV considerations) for AIF[AC], and then continues to count down the backoff until the backoff reaches zero. In some embodiments, after the wireless device has successfully transmitted a frame, the wireless device may increase the backoff to permit other wireless devices access to the wireless medium. In some embodiments, the wireless device must wait an extended inter-frame space (EIFS) after the wireless device detects a frame, but does not successfully demodulate the frame, where EIFS=aSIFSTime+ACK×Time DIPS, where ACKT×Time is the time required to transmit an acknowledgement (ACK) frame at the lowest mandatory physical (PHY) data rate. EIFS is intended to give a hidden wireless device time to ACK the frame that was not modulated correctly. The wireless device did not set a NAV based on the frame since the frame was not demodulated correctly.

A wireless device may use the channel access 202.1 method to access a channel. The wireless device may have already gained access to the wireless medium or the wireless device may be responding to a received packet. If the wireless device determines that the medium of the channel is idle during the SIFS 252. the wireless device may transmit burst and response access 254 after SIFS 252, e.g., acknowledgement (ACK), block ACK (BA), and clear-to-send (CTS).

A wireless device may access the wireless medium of a channel in accordance with channel access 202.2 method. If the wireless device determines that the medium of the channel is idle during PIFS 256, the wireless device may transmit priority access 258, e.g. a beacon frame.

The TXOP[AC] indicates how long a wireless device may use the wireless medium of the channel for. For example, a wireless device that has already sent a frame and received a response may transmit another frame after SIFS 252 if the duration the wireless device has used so far plus the new transmission is less than the TXOP[AC] where the time includes responses from other wireless devices, e.g., ACKs or UL data in response to a trigger frame (TF).

As illustrated there are eight channel accesses 202.1 through 202.8 that are different methods of accessing the wireless medium, but there are other methods of accessing the wireless medium that are not illustrated.

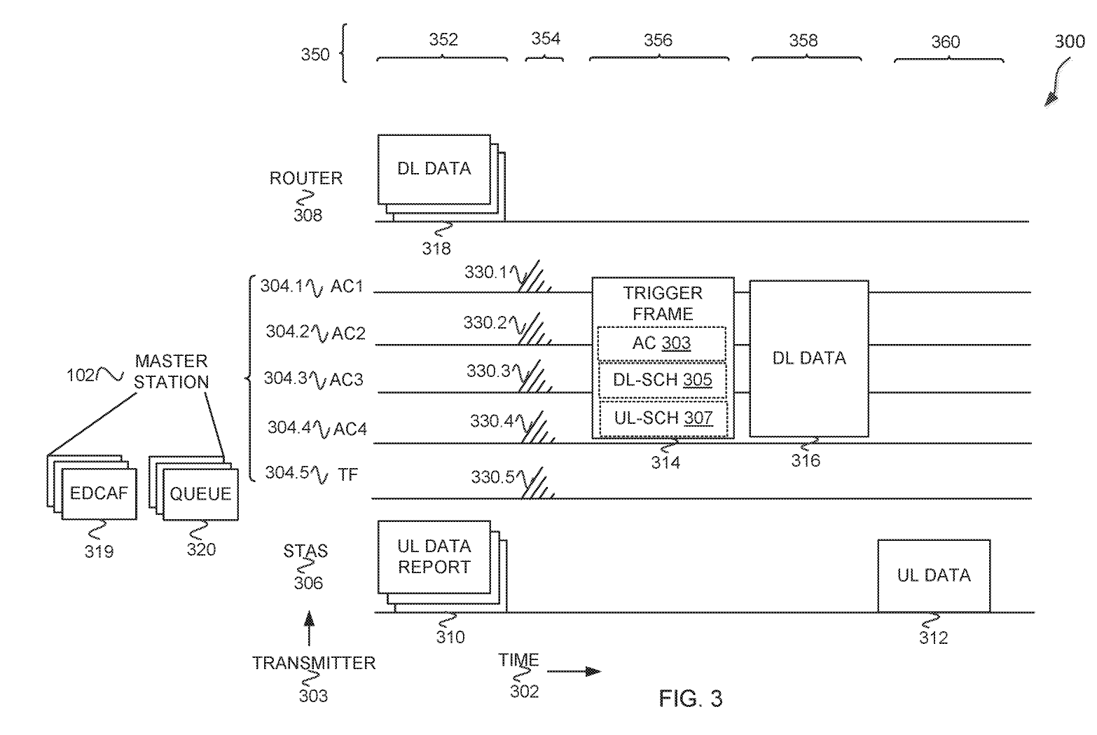

FIG. 3 illustrates a method 300 for access categories for trigger frames and EDCAF for master stations in accordance with some embodiments. Illustrated in FIG. 3 is time 302 along a horizontal axis, transmitter 303 along a vertical axis, and operations 350 along the top.

The router 308 may be a network equipment that sends DL data 318 to the master station 102. The DL data 318 may be data for STAs 306. In some embodiments, the router 308 may be connected to the Internet. In some embodiments, the router 308 may be integrated with the master station 102.

The master station 102 may include one or more EDCAFs 318. The EDCAFs 319 may implement EDCA in accordance with one or more embodiments described herein. In some embodiments there is an EDCAF 319 for each AC 304. In some embodiments there is one EDCAF 319 for DL data 318 and one EDCAF 319 for UL data reports 310. The master station 102 may include one or more queues 320. The queues 320 may store DL data 318 for the STAs 306. The queues 320 may store information regarding UL data reports 310. In some embodiments, the master station 102 may be configured to determine whether STAs 306 have UL data 312 based on an amount of time since the STAs 306 have transmitted UL data 312. The STAs 306 may be HE stations 104 and/or legacy devices 106.

The method 300 may optionally begin at operation 352 with the router 308 sending DL data 318 to the master station 102 and the STAs 306 transmitting UL data reports 310 to the master station 102. The UL data reports 310 may be part of other packets. The UL data reports 310 may be information elements. The UL data reports 310 may be one or more fields in a packet that indicates that the STA 306 has data to transmit to the master station 102 (e.g., resource requests). The UL data reports 310 may be in response to a polling request from the master station 102, which may have been trigger frame,

The method 300 continues at operation 354 with the master station 102 contending for the wireless medium. The master station 102 may contend for the wireless medium for a trigger frame. The master station 102 may contend with one or more of contending 330 for the corresponding ACs 304. The master station 102 may use only contending 330.5 for TF 304.5. The parameters of the EDCA may be in accordance with Table 1. Contending 330.5 may be in accordance with channel access 202.8 as disclosed in conjunction with FIG. 2. Contending 330.1 through 330.5 may be in accordance with the corresponding channel access 202.4 through 202.8 as disclosed in conjunction with FIG. 2. The parameters for the ACs 304 may be in accordance with Table 1 or another wireless communication standard.

The contending 330 may begin when the master station 102 determines a queue 320 is sufficiently full or the master station 102 may begin contending 330 when there is no data to UL or DL. One or more of the contending 330 may be started by the master station 102 simultaneously or at different times. One or more of the contending 330 may be started by the master station 102 simultaneously or at different times for the trigger frame 314.

When the master station 102 determines to send the trigger frame 314 to start a TXOP, the master station 102 may determine to start the contention with any AC 304 to transmit the trigger frame 314, in accordance with some embodiments. The master station 102 may be limited in the selection of the ACs 304 to ACs 304 that are not already contending 330. In some embodiments, an AC 304 is assigned to the trigger frame 314 that is the first frame to start a TXOP. In some embodiments, the master station 102 may start two or more AC 304 for contending 330, if the AC 304 are not already contending 330. The AC 304 that wins the contention may be used by the master station 102 for the trigger frame 314, in accordance with some embodiments.

In some embodiments, the master station 102 may determine EDCAF 319 parameters CWmin[AC_TF], CWmax[AC_TF], AIFSN[AC_TF], and TXOP_Limit[AC_TF], e.g., Table 1, A, B, C, and D, respectively. In some embodiments, the master station 102 determines the EDCAF 319 parameters for AC_TF, and then begins contending with the determined parameters.

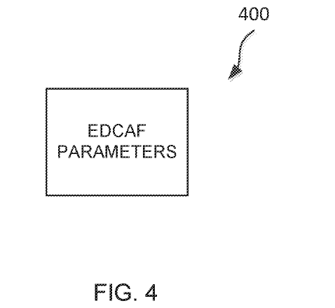

FIG. 4 will be described in conjunction with FIG. 3. FIG. 4 illustrates EDCAF parameters 400 in accordance with some embodiments. In some embodiments, the EDCAF parameters 400 may be transmitted and/or received in an information element and/or in a management frame, e.g. a beacon frame or action frame. In some embodiments, the master station 102 may receive an indication of determined EDCAF parameters 400 for AC_TF from a neighboring master station 102. The master station 102 may adjust the EDCAF parameters 400 for AC_TF based on the neighbor's EDCAF parameters 400 for AC_TF, e.g., the master station 102 may use the same EDCAF 318 parameters for AC_TF as the neighbor master station 102.

The method 300 continues at operation 356 with transmitting the trigger frame 314. One or more of the contending 330 has gained access to the channel in accordance with EDCA. For example, the master station 102 may use TF 304.5 as the AC and the contending 330.5 may have reached the point where the master station 102 may transmit a frame (e.g., trigger frame UL data 294 of FIG. 2).

The trigger frame 314 may have to conform to the parameters for an AC 304. For example, the trigger frame 314 may start a TXOP with an AC 304 and may need to insure the duration of the TXOP does not extend past the TXOP limit (see Table 1 for an example). The trigger frame 314 may optionally comprise one or more of an AC 303, DL-schedule 305, and UL schedule 307. The AC 303 may be an indication of the AC of the trigger frame, which may be used by the STAs 306. In some embodiments, the AC 303 may be an AC that is different than the AC of the trigger frame 314 and indicates the UL data 312 the STAs 306 may transmit. For example, the AC of the trigger frame 314 may be AC_TF and the AC 303 may be AC_VO (see Table 1). The DL-schedule 305 may be resource allocations for the STAs 306 to receive DL data 316. The UL-schedule 307 may be resource allocations for the STAs 306 to transmit UL data 312.

In some embodiments, if the trigger frame 314 transmission fails, then the EDCAF 318 will follow the method described in conjunction with FIG. 2 where the backoff 268, 274, 280, 286, 292 will be doubled as long as it does not exceed the CWmax (see Table 1).

The method 300 optionally continues at operation 358 with the master station 102 transmitting DL data 316 to the STAs 306 in accordance with the DL-schedule 305. The master station 102 may have to insure that the TXOP does not exceed a TXOP limit of the AC 304 used to gain access to the wireless medium. Some of the DL data 316 may be the DL data 318 received from the router 308.

In some embodiments, the STAs 306 may be restricted in the UL data 312 that may be transmitted based on the AC 303. For example, the STAs 306 may only be able to transmit data with the same AC as AC 303. In some embodiments, the STAs 306 may transmit any data. In some embodiments, the STAs 306 may only transmit data with an AC that the same as AC 303 or with a lower priority, e.g. AC_VI may be transmit with a AC_VO.

The method 300 optionally continues at operation 360 with the STAs 306 transmitting UL data 312 to the master station 102 in accordance with the UL-schedule 307. The STAs 306 may receive the AC 303. The master station 102 may have to insure that the TXOP does not exceed a TXOP limit of the AC 304 used to gain access to the wireless medium for the trigger frame.

In some embodiments, the UL data 312 may include an ACK or BA for the DL data 316. In some embodiments, the method 300 may include an operation 350 for the master station 102 to ACK or BA the UL data 312.

In some embodiments, a subsequent trigger frame (not illustrated) may be transmitted during the TXOP began by the trigger frame 314. The master station 102 may transmit the subsequent trigger frame without associating the subsequent trigger frame with an AC by following the trigger frame 314, e.g. the master station 102 is still bound by the TXOP limit of the TXOP begun by the trigger frame 314. The master station 102 and/or STAs 306 may be configured to perform the method 300.

In some embodiments, the DL data 318, DL data 316, UL data report 310, and/or UL data 312 may include a traffic identification (TID) which may identify a traffic class to which the frame or packet belongs. The TID may carry a priority which may be mapped to an AC, e.g., priority 1, 2 mapped to AC_BK; priority 0, 3 mapped to AC_BE ; priority 4, 5 mapped to AC_VI; and, priority 6, 7 mapped to AC_VO.

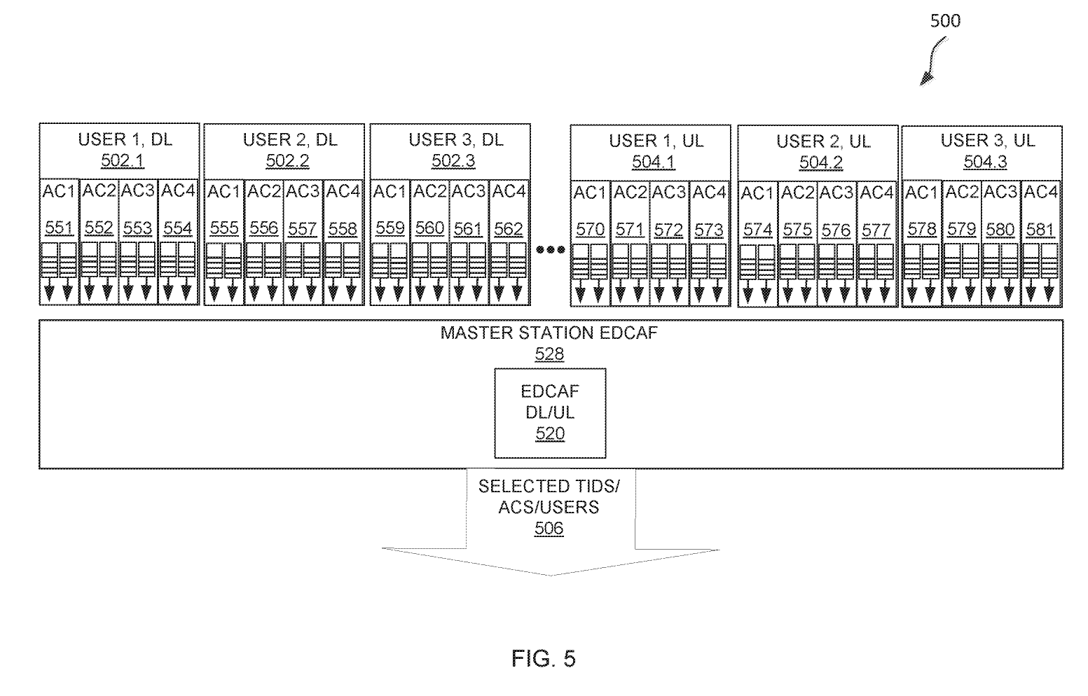

FIG. 5 illustrates a method 500 for access categories for trigger frames and EDCAF for master stations in accordance with some embodiments. Illustrated in FIG. 5 are user DL 502 queues, user UL 504 queues, master station EDCAF 528, and selected TIDS/ACS/STAS 506. The user DL 502 queues may be per user, e.g. per STA 306. The user DL 502 queues may be queues 320 and/or resource indications. The user DL 402 queue may be per AC 451 through 462 with a queue for each AC per user, e.g., user 1, DL 502.1 includes AC1 551, AC2 552, AC3 553, and AC4 554. The master station 102 (e.g., FIG. 3) may be configured to separate indications of DL resources (e.g., data 318) in accordance to the user and the AC 551 through AC 562.

User UL 504 queues may be per user, e.g. per STA 306. The user UL 504 queues may be queues 320 and/or resource indications. The master station EDCAF 528 may be configured to separate indications of UL resources (e.g., UL data reports 310) based on the user (e.g., STA 306) and the AC 570 through AC 581.

The master station 102 EDCAF 528 (e.g., EDCAF 319) may be configured to select between UL and DL data resources based on the DL resource indication queues 502 and the UL resource indication queues 504 for maintaining fairness and quality of service (QoS) restrictions in scheduled DL and UL and a combination of UL and DL MU simultaneous transmissions.

The master station EDCAF 528 may determine selected TIDs/ACs/Users 506 based on one or more scheduling considerations as described herein. The master station EDCAF 528 may configure the EDCAF DL/UL 520 for channel access to gain access to the wireless medium, e.g., select an AC 304 to use. For example, the master station EDCAF 528 may select an AC 304 for a trigger frame (e.g., trigger frame 314) based on the selected TIDS/ACS/STAS 506 to transmit DL data (e.g., DL data 316) and/or transmit UL data (e.g., UL-schedule 307 for the STAs 306 to transmit UL data 312). The EDCAF 528 may configure the trigger frame 314 to include an indication of the type of data, e.g., TIDs or ACs, that the STAs 306 are to transmit in UL data 312. In some embodiments, the EDCAF DL/UL 520 may perform the channel access methods described in conjunction with FIG. 2. In some embodiments, the EDCAF DL/UL 520 may perform the channel access methods before the master station EDCAF 528 has determined selected TIDs/ACs/Users 506.

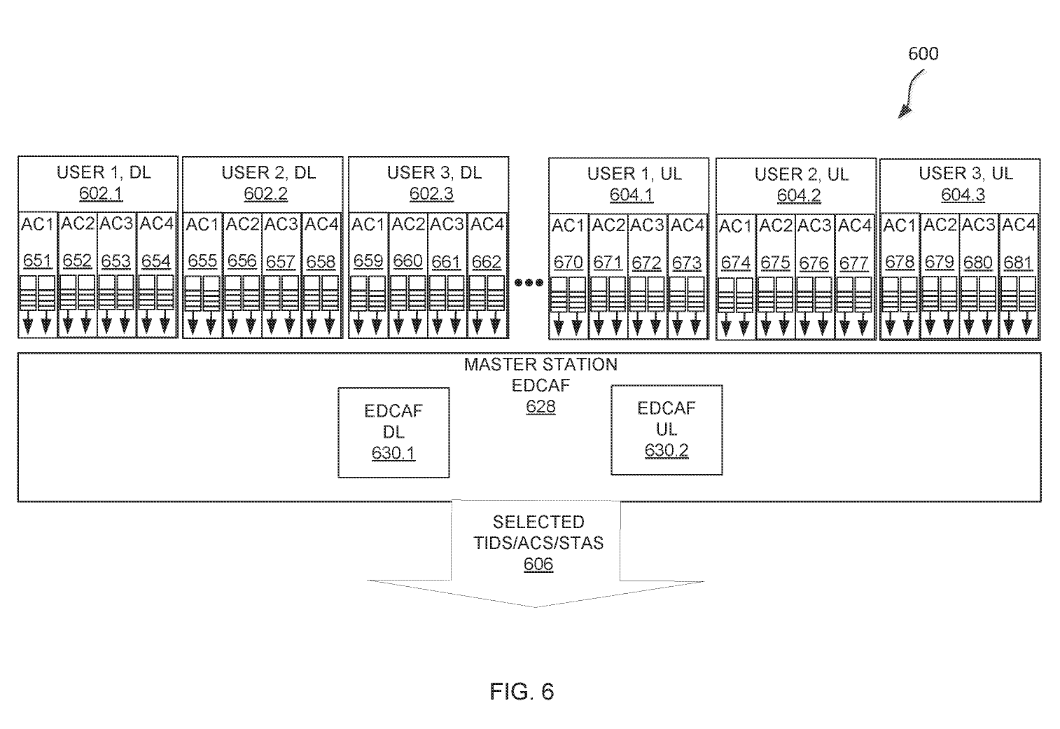

FIG. 6 illustrates a method 600 for access categories for trigger frames and EDCAF for master stations in accordance with some embodiments. Illustrated in FIG. 6 are user DL 602 queues, user UL 604 queues, master station EDCAF 628, and selected TIDs/ACs/Users 606. The user DL 602 queues may be per user, e.g. per STA 306. The user DL 602 queues may be queues 320 and/or resource indications. The user DL 602 queue may be per AC 651 through 662 with a queue for each AC per user, e.g., user 1, DL 602.1 includes AC1 651, AC2 652, AC3 653, and AC4 654. The master station EDCAF 628 (e.g., master station 102, FIG. 3) may be configured to separate indications of DL resources (e.g., data 318) in accordance to the user and the AC 651 through AC 662. The master station EDCAF 628 (e.g., master station 102, FIG. 3) may be configured to separate indications of UL resources (e.g., data 318) in accordance to the user and the AC 670 through AC 681.

User UL 604 queues may be per user, e.g. per STA 306. The user UL 504 queues may be queues 320 and/or resource indications. The master station EDCAF 628 (e.g., master station 102, FIG. 3) may be configured to separate indications of UL resources (e.g., data 318) in accordance to the user and the AC 670 through AC 681.

The master station EDCAF 628 (e.g., EDCAF 319) may be configured to select among the user DL 602 when the EDCAF DL 630.1 gains access to the wireless medium for maintaining fairness and quality of service (QoS) restrictions in scheduled DL MU simultaneous transmissions, e.g., select among the users and the ACs to maintain fairness.

The master station 102 EDCAF 628 (e.g., EDCAF 319) may be configured to select among the user UL 604 when the EDCAF DL 630.2 gains access to the wireless medium for maintaining fairness and quality of service (QoS) restrictions in scheduled UL MU simultaneous transmissions, e.g., select among the users and the ACs to maintain fairness.

The master station EDCAF 628 may determine selected TIDs/ACs/USERs 606 based on one or more scheduling considerations as described herein. The master station EDCAF 628 may configure the EDCAF DL 630.1 and/or the EDCAF UL 630.2 for channel access to gain access to the wireless medium, e.g., select an AC 304 to use. For example, the master station EDCAF 628 may select an AC 304 for a trigger frame (e.g., trigger frame 314) based on the selected TIDs/ACs/Users 606 to transmit DL data (e.g., DL data 316) and/or transmit UL data (e.g., UL-schedule 307 for the STAs 306 to transmit UL data 312). The master station EDCAF 628 may configure the trigger frame 314 to include an indication of the type of data, e.g., TIDs or ACs, that the STAs 306 are to transmit in UL data 312. In some embodiments, the EDCAF DL 630.1 and/or EDCAF UL 630.2 may perform the channel access methods described in conjunction with FIG. 2. In some embodiments, the EDCAF DL 630.1 and/or EDCAF UL 630.2 may perform the channel access methods before the master station EDCAF 628 has determined selected TIDs/ACs/Users 606.

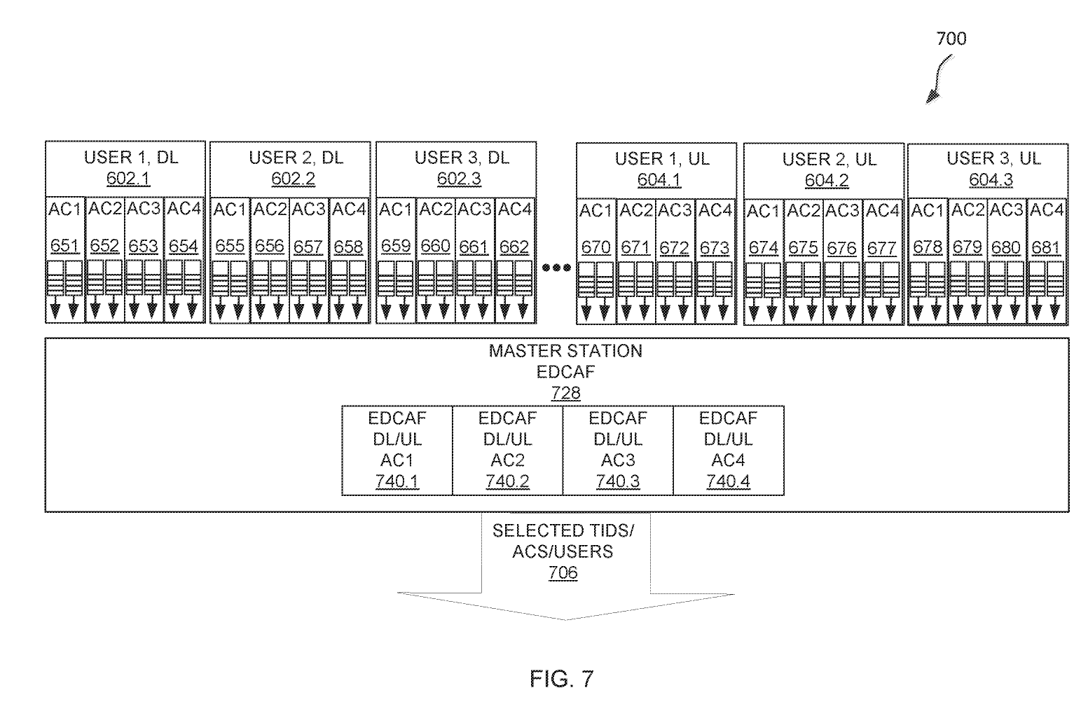

FIG. 7 illustrates a method 700 for access categories for trigger frames and EDCAF for master stations in accordance with some embodiments. Illustrated in FIG. 7 are user DL 602 queues, user UL 604 queues, master station EDCAF 728, and selected TIDs/ACs/Users 606.

The master station EDCAF 728 (e.g., EDCAF 319) may comprise EDCAF DL/UL AC1 740.1, EDCAF DL/UL AC2 740.2, EDCAF DL/UL AC3 740.3, and EDCAF DL/UL AC4 740.4. Each of the EDCAF DL/UL may be for serving the corresponding AC. For example, EDCAF DL/UL AC1 740.1 may be for serving AC1 651, AC1 655, AC1 659, AC1 670, AC1 674, and AC1 678.

The EDCAF DL/UL AC 740 may be configured to contend for the wireless medium. In some embodiments, the EDCAF DL/UL AC 740 may contend for the wireless medium only after the user DL queues and user UL queues for the corresponding ACs reach a certain level of fullness. In some embodiments, the EDCAF MAT AC 740 may be configured to contend for the wireless medium even when the corresponding queues do not indicate there is data to transmit in the UL or the DL.

When a EDCAF DL/UL AC 740 gains access of the wireless medium, the master station EDCAF 728 may be configured to select the resources for a trigger frame for maintaining fairness and quality of service (QoS) restrictions in scheduled DL MU simultaneous transmissions, e.g., the master station EDCAF 728 may select data to be transmitted in the DL in accordance with the AC and in a first come first serve basis.

The master station EDCAF 728 may determine selected TIDs/ACs/Users 706 based on one or more scheduling considerations as described herein. The master station EDCAF 728 may select an AC 304 for a trigger frame (e.g., trigger frame 314) based on the selected TIDs/ACs/Users 706 to transmit DL data (e.g., DL data 316) and/or transmit UL data (e.g., UL-schedule 307 for the STAs 306 to transmit UL data 312). The master station EDCAF 728 may configure the trigger frame 314 to include an indication of the type of data, e.g., TIDs or ACs, that the STAs 306 are to transmit in UL data 312. In some embodiments, the EDCAF DL/UL AC 740 may perform the channel access methods described in conjunction with FIG. 2.

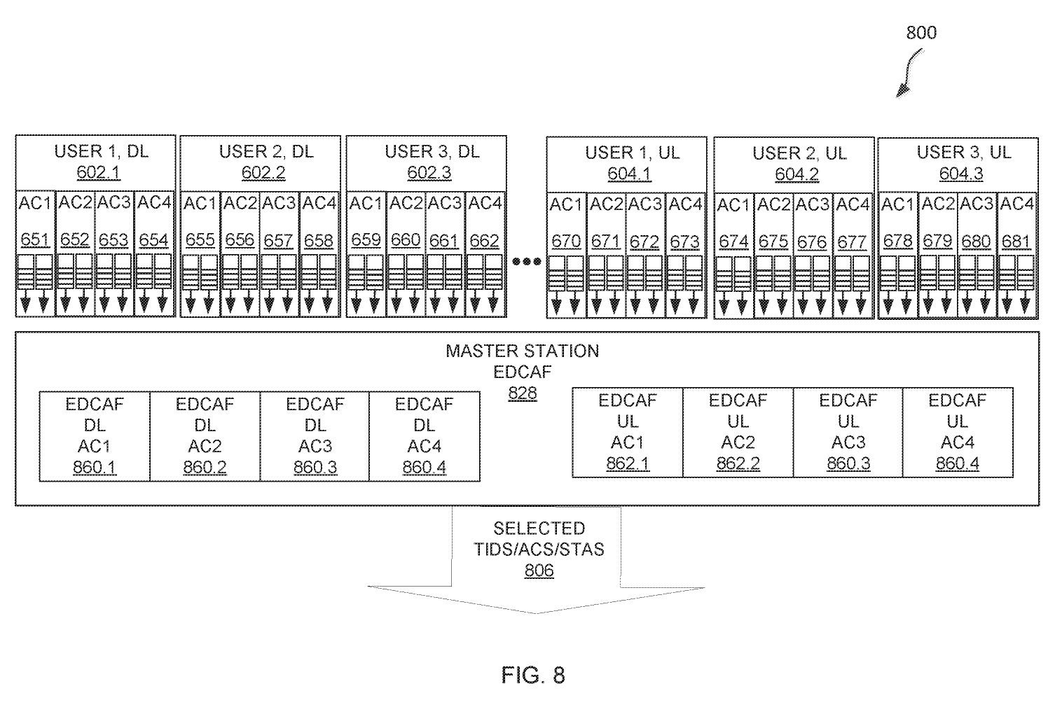

FIG. 8 illustrates a method 800 for access categories for trigger frames and EDCAF for master stations in accordance with some embodiments. Illustrated in FIG. 8 are user DL 602 queues, user UL 604 queues, master station EDCAF 828, and selected TIDs/ACs/Users 806.

The master station EDCAF 828 (e.g., EDCAF 319) may comprise EDCAF DL AC1 860.1, EDCAF DL AC2 860.2, EDCAF DL AC3 860.3, EDCAF DL AC4 860.4, EDCAF UL AC1 860,1, EDCAF UL AC2 860.2, EDCAF UL AC3 860.3, and EDCAF UL AC4 860.4.

Each of the EDCAF DL AC 860 and EDCAF UL AC 862 may be for serving the corresponding AC. For example, EDCAF DL AC1 860.1 may be for serving AC1 651, AC1 655, and AC1 659.

The EDCAFs DL AC 860 and EDCAFs UL AC 862 may be configured to contend for the wireless medium. In some embodiments, the EDCAFs DL AC 860 and EDCAFs UL AC 862 may contend for the wireless medium only after the user DL queues and user UL queues for the corresponding ACs reach a certain level of fullness. In some embodiments, the EDCAFs DL AC 860 and EDCAFs UL AC 862 may be configured to contend for the wireless medium even when the corresponding queues do not indicate there is data to transmit in the UL or the DL.

When a EDCAFs DL AC 860 and EDCAFs UL AC 862 gains access of the wireless medium, the master station EDCAF 728 may be configured to select the resources for a trigger frame for maintaining fairness and quality of service (QoS) restrictions in scheduled DL MU simultaneous transmissions, e.g., the master station EDCAF 828 may select data to be transmitted in the DL in accordance with the AC and in a first come first serve basis.

The master station EDCAF 828 may determine selected TIDs/ACs/Users 806 based on one or more scheduling considerations as described herein. The master station EDCAF 828 may select an AC 304 for a trigger frame (e.g., trigger frame 314) based on the selected TIDs/ACs/Users 806 to transmit DL data (e.g., DL data 316) and/or transmit UL data (e.g., UL-schedule 307 for the STAs 306 to transmit UL data 312). The master station EDCAF 828 may configure the trigger frame 314 to include an indication of the type of data, e.g., TIDs or ACs, that the STAs 306 are to transmit in UL data 312. In some embodiments, the EDCAFs DL AC 860 and EDCAFs UL AC 862 may perform the channel access methods described in conjunction with FIG. 2.

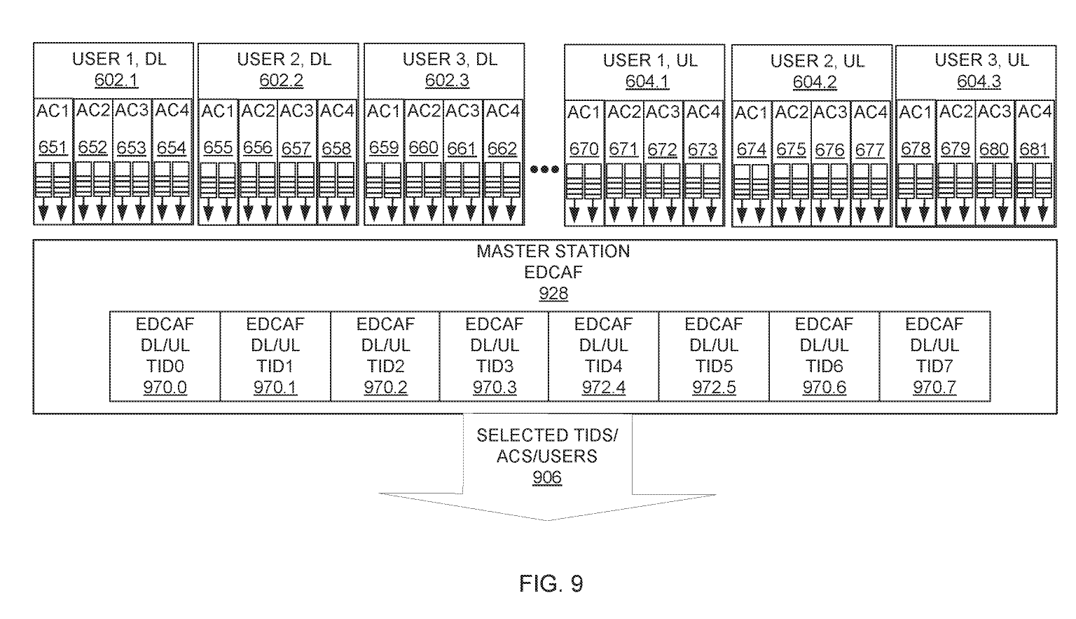

FIG. 9 illustrates a method 900 for access categories for trigger frames and EDCAF for master stations in accordance with some embodiments. Illustrated in FIG. 9 are user DL 602 queues, user UL 604 queues, master station EDCAF 928, and selected TIDs/ACs/Users 906. In some embodiments, the user DL 602 queues and the user UL 604 queues may comprise a TID queue for each of TID 0 through TID 7,

The master station EDCAF 928 (e.g., EDCAF 319) may comprise EDCAF DL/UL TID0 970.0, EDCAF DL/UL TID1 970.1, EDCAF TID2 970.2, EDCAF DL/UL TID3 970.3, EDCAF DL/UL TID4 970.4, EDCAF DL/UL TID5 970.5, EDCAF DL/UL TID6 970.6, and EDCAF DL/UL TID7 970.7.

Each of the EDCAF DL/UL TID 970 may be for serving the corresponding TID or AC. For example, EDCAF DL TID0 970.0 may be for serving AC1 651, AC1 655, AC1 659, AC1 670, AC1 674, and AC1 678; or, a DL TID0 for user 1, a DL TID0 for user 2, a DL TID0 for user 3, a UL TID0 for user 1, a UL TID0 for user 2, and a UL TID0 for user 3.

The EDCAFs DL/UL TID 970 may be configured to contend for the wireless medium. In some embodiments, the EDCAFs DL/UL TID 970 may contend for the wireless medium only after the user DL queues and user UL queues for the corresponding ACs or TIDs reach a certain level of fullness. In some embodiments, the EDCAFs DL/UL TID 970 may be configured to contend for the wireless medium even when the corresponding queues do not indicate there is data to transmit in the UL or the DL.

When a EDCAFs DL/UL TID 970 gains access of the wireless medium, the master station EDCAF 928 may be configured to select the resources for a trigger frame for maintaining fairness and quality of service (QoS) restrictions in scheduled DL MU simultaneous transmissions, e.g., the master station EDCAF 928 may select data to be transmitted in the DL in accordance with the AC or TID and in a first come first serve basis.

The master station EDCAF 928 may determine selected TIDs/ACs/Users 906 based on one or more scheduling considerations as described herein. The master station EDCAF 928 may select an AC 304 for a trigger frame (e.g., trigger frame 314) based on the selected TIDs/ACs/Users 906 to transmit DL data (e.g., DL data 316) and/or transmit UL data UL-schedule 307 for the STAs 306 to transmit UL data 312). The master station EDCAF 928 may configure the trigger frame 314 to include an indication of the type of data, e.g., TIDs or ACs, that the STAs 306 are to transmit in UL data 312. In some embodiments, the EDCAFs DL/UL TID 970 may perform the channel access methods described in conjunction with FIG. 2.

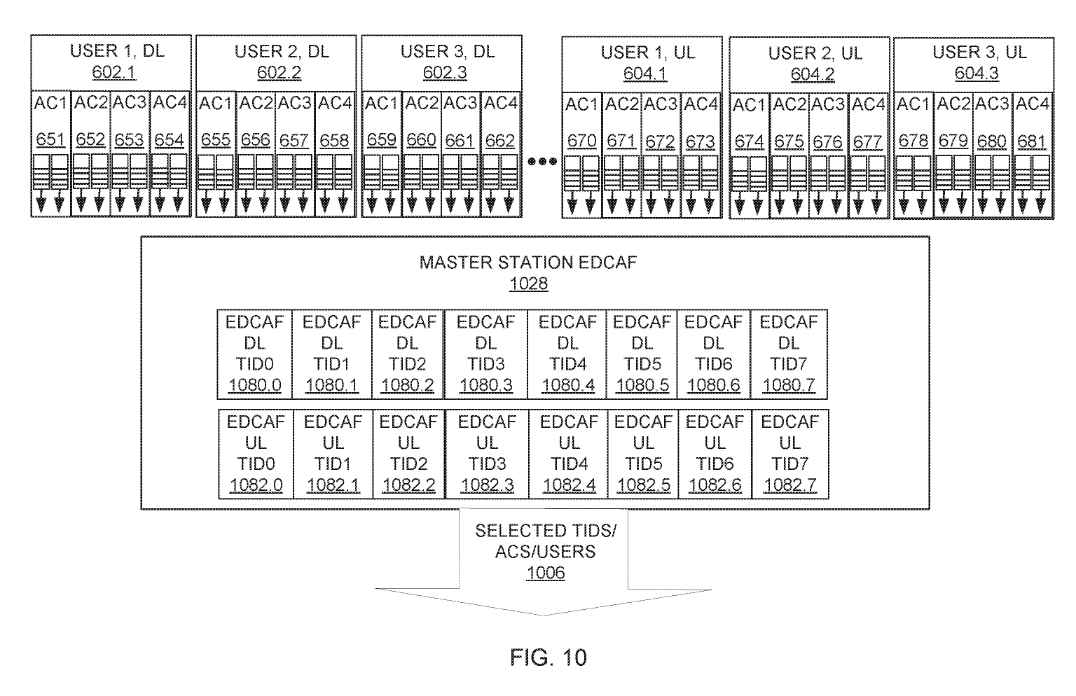

FIG. 10 illustrates a method 1000 for access categories for trigger frames and EDCAF for master stations in accordance with some embodiments. Illustrated in FIG. 10 are user DL 602 queues, user UL 604 queues, master station EDCAF 1028, and selected TIDs/ACs/Users 1006. In some embodiments, the user DL 602 queues and the user UL 604 queues may comprise a TID queue for each of TID 0 through TID 7.

The master station EDCAF 1028 (e.g., EDCAF 319) may comprise EDCAF DL TID0 1080.0, EDCAF DL TID1 1080.1, EDCAF DL TID2 1080.2, EDCAF DL TID3 1080.3, EDCAF DL TID4 1080.4, EDCAF DL TID5 1080.5, EDCAF DL TID6 1080.6, EDCAF DL TID7 1080.7, EDCAF UL TID0 1082.0, EDCAF UL TID1 1082.1, EDCAF UL TID2 1082.2, EDCAF UL TID3 1082.3, EDCAF UL TID4 1082.4, EDCAF UL TID5 1082.5, EDCAF UL TID6 1082.6, and EDCAF UL TID7 1082.7.

Each of the EDCAF DL TID 1080 and EDCAF UL TID 1082 may be for serving the corresponding TID or AC. For example, EDCAF DL TID0 1080.0 may be for serving AC1 651, AC1 655, AC1 659; or, a DL TID0 for user 1, a DL TID0 for user 2, and a DL TID0 for user 3.

EDCAF DL TID 1080 and EDCAF UL TID 1082 may be configured to contend for the wireless medium. In some embodiments, EDCAF DL TID 1080 and EDCAF UL TID 1082 may contend for the wireless medium only after the user DL queues and user UL queues for the corresponding ACs or TIDs reach a certain level of fullness. In some embodiments, EDCAF DL 1080 and EDCAF UL TID 1082 may be configured to contend for the wireless medium even when the corresponding queues do not indicate there is data to transmit in the UL or the DL.

When a EDCAF DL TID 1080 or EDCAF UL TID 1082 gains access of the wireless medium, the master station EDCAF 928 may be configured to select the resources for a trigger frame for maintaining fairness and quality of service (QoS) restrictions in scheduled DL MU simultaneous transmissions, e.g., the master station EDCAF 1028 may select data to be transmitted in the DL in accordance with the AC or RD and in a first come first serve basis.

The master station EDCAF 1028 may determine selected TIDs/ACs/Users 1006 based on one or more scheduling considerations as described herein. The master station EDCAF 1028 may select an AC 304 for a trigger frame (e.g., trigger frame 314) based on the selected TIDs/ACs/Users 1006 to transmit DL data (e.g., DL data 316) and/or transmit UL data (e.g., UL-schedule 307 for the STAs 306 to transmit UL data 312). The master station EDCAF 1028 may configure the trigger frame 314 to include an indication of the type of data, e.g., TIDs or ACs, that the STAs 306 are to transmit in UL data 312. In some embodiments, EDCAF DL TID 1080 and EDCAF UL TID 1082 may perform the channel access methods described in conjunction with FIG. 2.

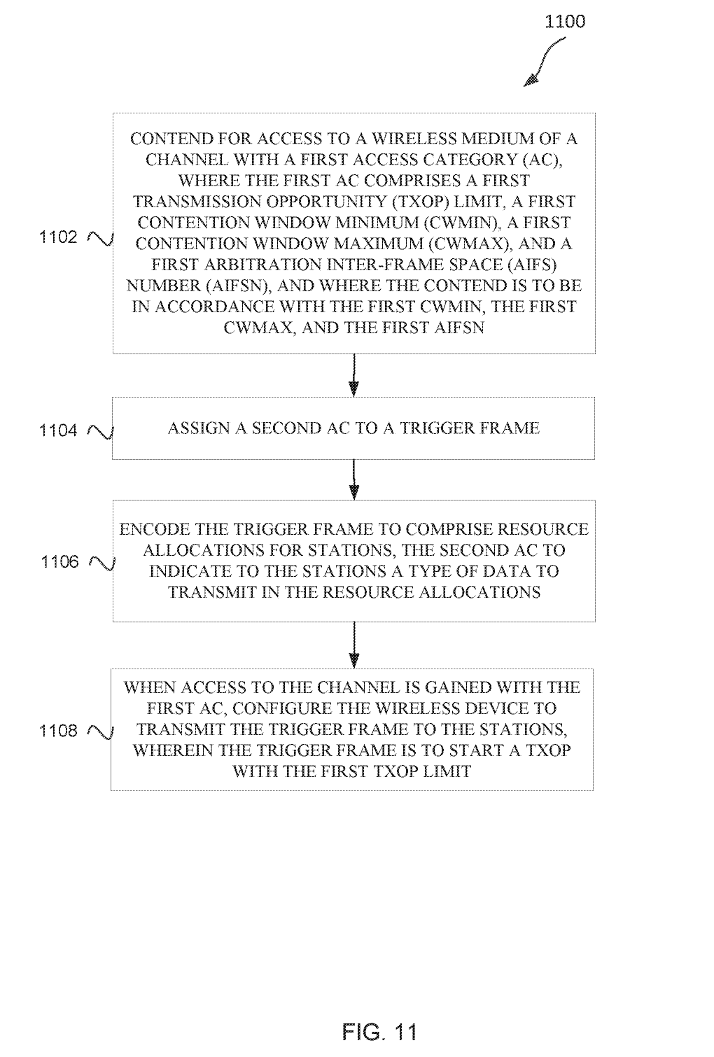

FIG. 11 illustrates a method 1100 for access categories for trigger frames and EDCAF for master stations in accordance with some embodiments. The method 1100 begins at operation 1102 with contending for access to a wireless medium of a channel with a first AC, where the first AC comprises a first TXOP limit, a first CWmin, a first CWmax, and a first AIFSN, and where the contend is to be in accordance with the first CWmin, the first CWmax, and the first AIFSN. For example, master station 102 (FIG. 3) may contend for the wireless medium of a channel using one of the ACs 304 and associated EDCAF parameters 400.

The method 1100 may continue at operation 1104 with assigning a second AC to a trigger frame. For example, the master station 102 (FIG. 3) may assign AC 303 to a second AC.

The method 1100 may continue at operation 1106 with encoding the trigger frame to comprise resource allocations for stations, the second AC to indicate to the stations a type of data to transmit in the resource allocations. For example, the master station 102 may encode the trigger frame 314 with UL-sch 307 with AC 303 that may indicate to STAs 306 a type of data to transmit using the UL-SCH 307.

The method 1100 may continue at operation 1108 with when access to the channel is gained with the first AC, configuring the wireless device to transmit the trigger frame to the stations, where the trigger frame is to start a TXOP with the first TXOP limit. For example, master station 102 may gain access to the wireless medium of the channel at 330, and an apparatus of the master station 102 may configure the master station 102 to transmit the trigger frame 314.

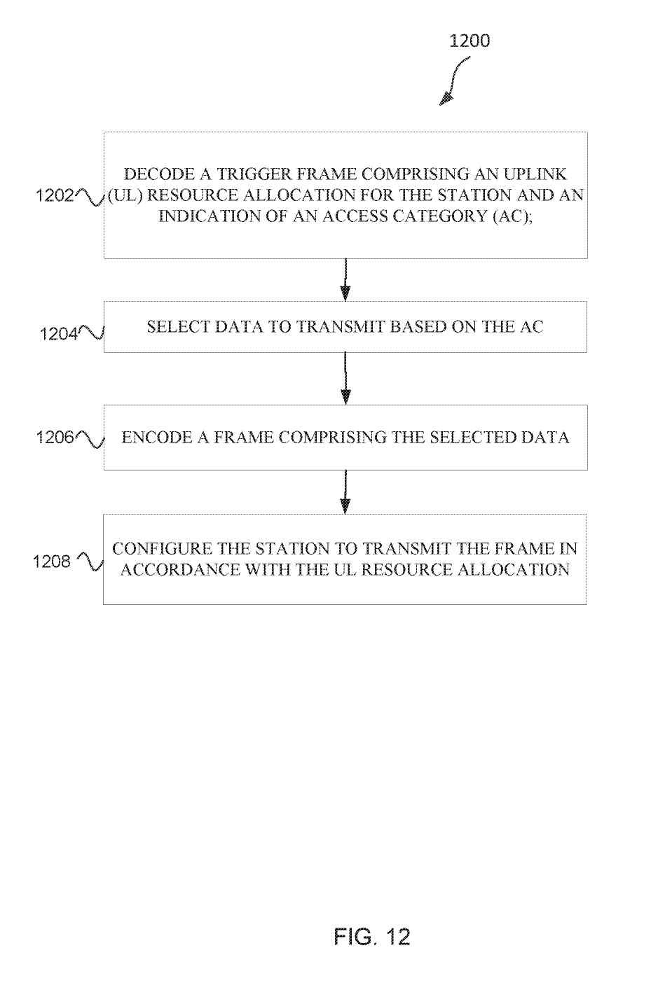

FIG. 12 illustrates a method 1200 for access categories for trigger frames and EDCAF for master stations in accordance with some embodiments. The method 1200 may begin at operation 1202 with decoding a trigger frame comprising an UL resource allocation for the station and an indication of an AC. For example, STAs 306 may receive trigger frame 314 (FIG. 3).

The method 1200 may continue at operation 1204 with selecting data to transmit based on the AC. For example, STAs 306 may select UL data 312 based on the AC 303. The method 1200 continues at operation 1206 with encoding a frame comprising the selected data. For example, the STAs 306 may encode the UL data 312. The method 1200 continues at operation 1208 with configuring the station to transmit the frame in accordance with the UL resource allocation. For example, an apparatus of a STA 306 may configure the STA 306 to transmit the UL data 312 in accordance with the UL-schedule 307.

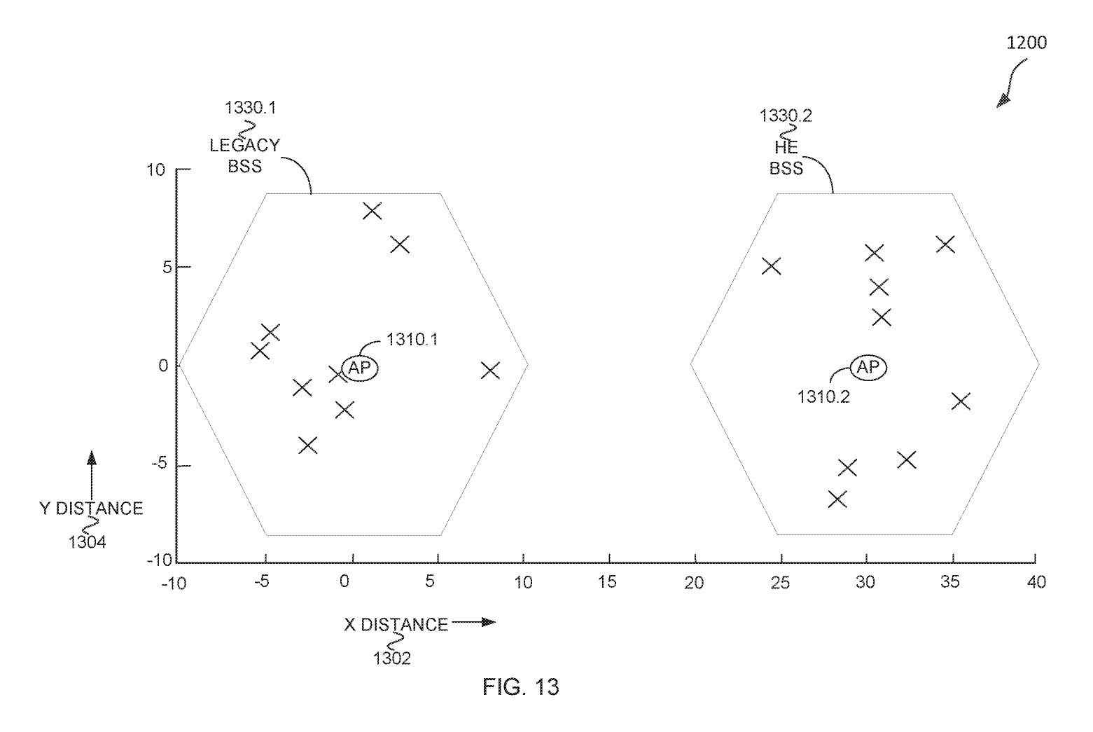

FIG. 13 illustrates a simulation with a legacy BSS 1330.1 and HE BSS 1330.2 in accordance with some embodiments. Illustrated in FIG. 13 is an X distance 1302 in meters along a horizontal axis, a y distance 1304 in meters along a vertical axis, a legacy BSS 1330.1, and a HE 1330.2 BSS. The legacy BSS 1330.1 includes an AP 1310.1 configured to operate in accordance with a legacy communication standard and an AP 1310.2 that is configured to operate in accordance with an HE embodiment, e.g., a master station 102. The legacy BSS 1330.1 includes nine legacy stations 106. The FIE BSS 1330.2 include nine HE stations 104.

Table 1 illustrates a simulation results for legacy vs, HE embodiments for UL Traffic. In Case 1, the AP 1310.2 (e.g., master station 102) and HE stations 104 are configured to use EDCA to access the channel for UL data. In Case 2, the master station 102 is configured to access the channel to trigger UL data from the HE stations 106 (e.g., start a TXOP and send a trigger frame with RUs for the HE stations 106). The legacy BSS 1330.1 and HE BSS 1330.2 are overlapping BSSs to one another. In case 2, the legacy BSS 1330.1 performs better than the HE BSS 1330.2 (6.88 Mpbs vs. 56.78) because the AP 1310 (e.g., master station 102) is the only device that is contending for the wireless medium for the UL data in the HE BSS 1330.2 whereas all the devices in the legacy BSS 1330.1 may contend for the wireless medium.

TABLE 1
Simulation Results for Legacy vs. HE Embodiments for UL
Traffic.

| | Case 1 | Case 2 |
|---|---|---|
| | HE: EDCA only | HE: UL MU Only |
| AX BSS (Mbps) | 26.12 | 6.88 |
| Legacy BSS (Mbps) | 38.0 | 56.78 |

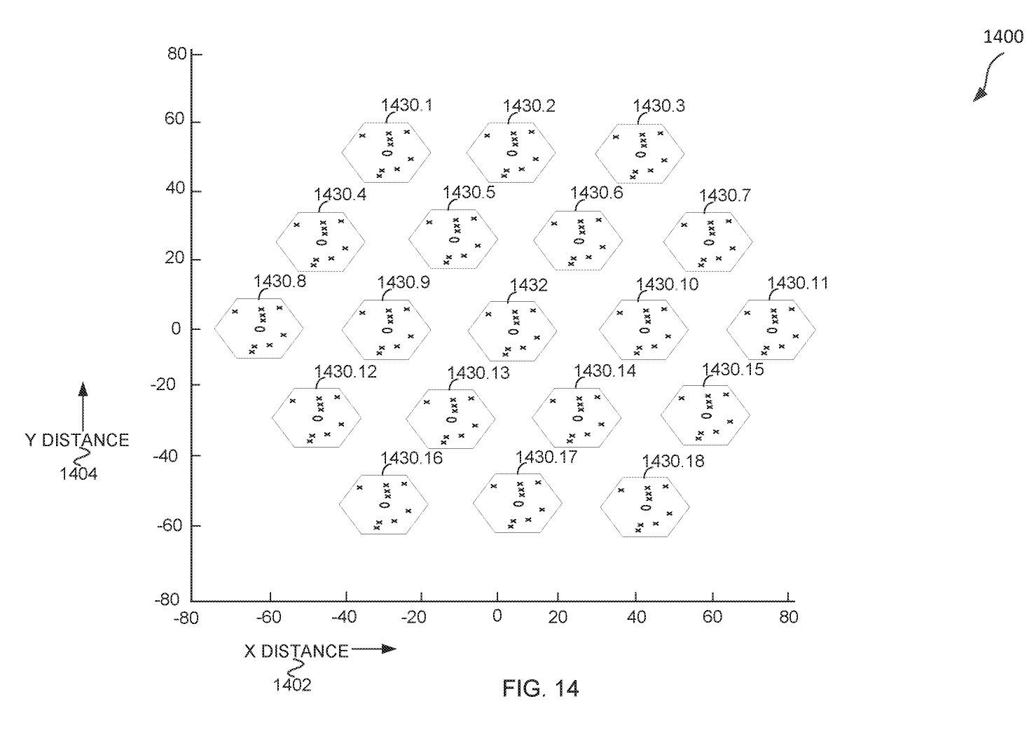

FIG. 14 illustrates a simulation with legacy devices 1430.1 and HE devices 1432 in accordance with some embodiments. Illustrated in FIG. 14 is an X distance 1402 in meters along a horizontal axis, a y distance 1404 along a vertical axis, legacy BSSs 1430, and HE BSS 1432. Each legacy BSS 1430.1 through legacy BSS 1430.18 includes nine stations and one AP. The legacy BSSs 1430 operate in accordance with legacy EDCA. The HE BSS 1432 includes nine HE stations 104 and one HE AP, e.g., master station 102.

Table 2 illustrates a simulation results for legacy vs. HE embodiments for UL Traffic. In Case 1, the HE AP (e.g., master station 102) and HE stations 104 are configured to use EDCA to access the channel for UL data. In Case 2, the HE AP (e.g., master station 102) is configured to access the channel to trigger UL data from the HE stations 106 start a TXOP and send a trigger frame with RUs for the HE stations 106). The legacy BSSs 1430 and HE BSS 1332 are overlapping BSSs with one another. In case 2, the performance of the HE BSS 1432 is reduced from 5.8092 to 0.6168 Mpbs because the HE AP (e.g., master station 102) of the HE BSS 1430 is the only device that is contending for the wireless medium for the UL data in the HE BSS 1332 whereas all the devices in the legacy BSSs 1330 may contend for the wireless medium.

TABLE 2
Simulation Results for Legacy vs HE Embodiments for UL Data

| | Case 1: HE BSS: EDCA | Case 2: HE: UL MU |
|---|---|---|
| | Only | Only |
| HE BSS (Mbps) | 5.8092 | 0.6168 |

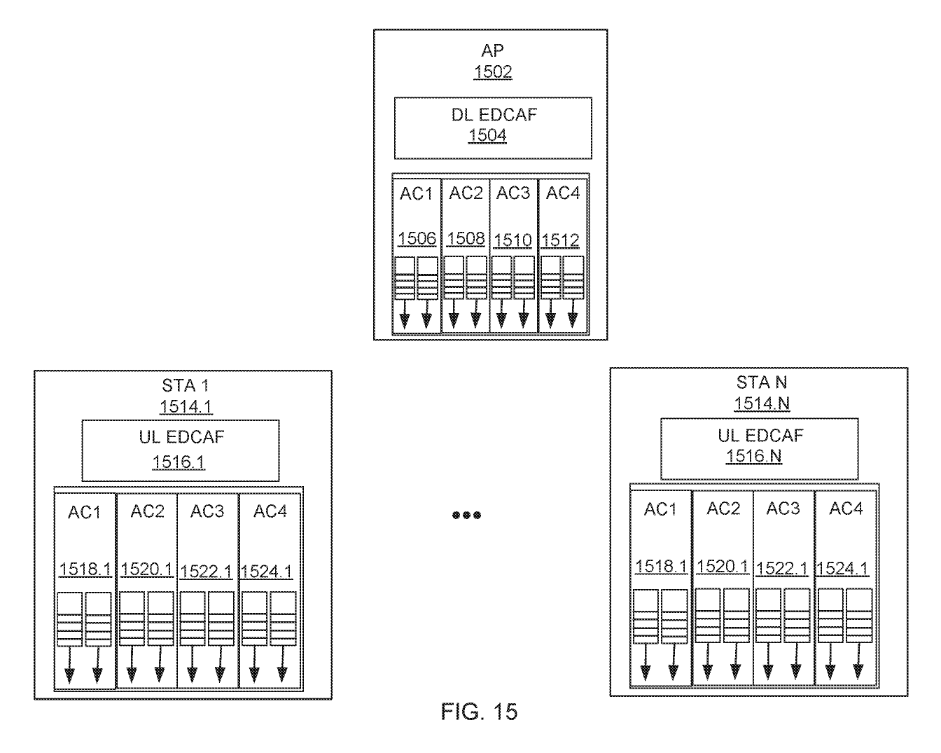

FIG. 15 illustrates a access categories for EDCAF in accordance with some embodiments. Illustrated in FIG. 15 is AP 1502, and STA 1 1514.1 through STAN 1514.N. The AP 1502 includes a DL EDCAF 1504, AC1 1506, AC2 1508, AC3 1510, and AC4 1512. The AC1 1506, AC2 1508, AC3 1510, and AC4 1512 may be queues for DL data (e.g., management frames and data) where the download data is sorted by AC. The DL EDCAF 1504 may access the wireless medium as described in conjunction with FIG. 2. In some embodiments, the AP 1502 only has a DL EDCAF 1504 and not an UL EDCAF. The STA 1514.1 through STA N 1514.N may include a DL EDCAF 1516, AC1 1518, AC2 1520, AC3 1522, and AC4 1524. The AC1 1518, AC2 1520, AC3 1522, and AC4 1524 may be queues for UL data (e.g., management frames and data) where the UL data is sorted by AC. The UL EDCAF 1516 may access the wireless medium as described in conjunction with FIG. 2 to transmit data from the AC1 1518, AC2 1520. AC3 1522, and AC4 1524.

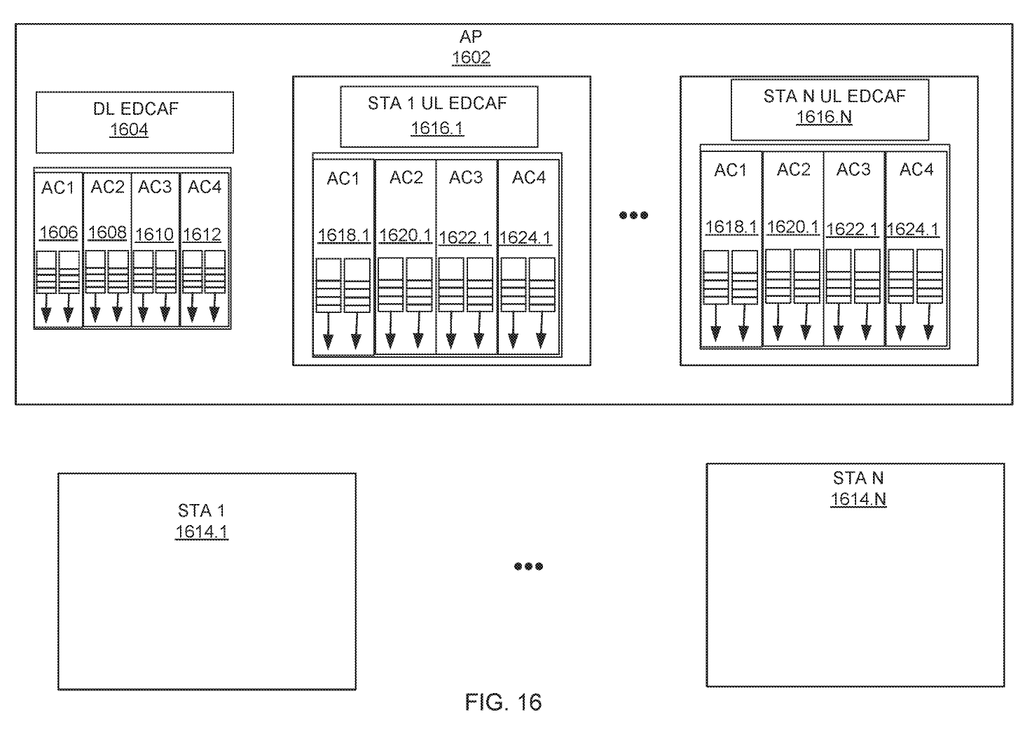

FIG. 16 illustrates a block diagram of an example of EDCAF for AP access for UL MU transmission in accordance with some embodiments. Illustrated in FIG. 16 is AP 1602 and STA 1 1614.1 through STA N 1614.N. The STA 1 1614.1 through STA N 1614.N may be associated with the AP 1602. The AP 1602 may be a master station 102. The STAs 1614 may be HE stations 106. The AP 1602 may determine whether the STAs 1614 are active based on, e.g., buffer status and information resource requests. The AP 1602 may maintain an STA 1 UL EDCAF 1616.1 through STA N UL EDCAF 1616.N for each active STA 1614. The AP 1602 may start each EDCAF 1616 to gain access to the wireless medium. In some embodiments, the AP 1602 may then serve the STA 1 1614.1 through STA N 1614.N. In some embodiments, the AP 1602 encodes a trigger frame (e.g., trigger frame 314) for the STAs 1614. The UL EDCAF is transferred from the STA 1 1614.1 through STA N 1614.N to the AP 1602.

In some embodiments, the AP 1602 may include the AC 303 to indicate to the STAs 1614 which type of data to include in UL data (e.g., 312). In some embodiments, the AP 1602 assigns a new random number to the STA UL EDCAF 1616 that gained access to the wireless medium. The AP 1602 may assign the new random number in accordance with EDCA as described in conjunction with FIG. 2. In some embodiments, the STAs 1614 may use local EDCAF to access the wireless medium to transmit UL data. In some embodiments, the AP 1602 may indicate parameters for the STAs 1614 to use for a local EDCAF. For example the EDCA parameters may include TXOP limit, a first CWmin, a CWmax, and a first AIFSN. In some embodiments internal collisions between different STA UL EDCAFs 1616 are resolved, e.g., the EDCAF with more data indications in an AC with a higher priority may win. In some embodiments, the AP 1602 may fill a TXOP with resource allocations for the STAs 1614 prioritizing the higher priority first ACs.

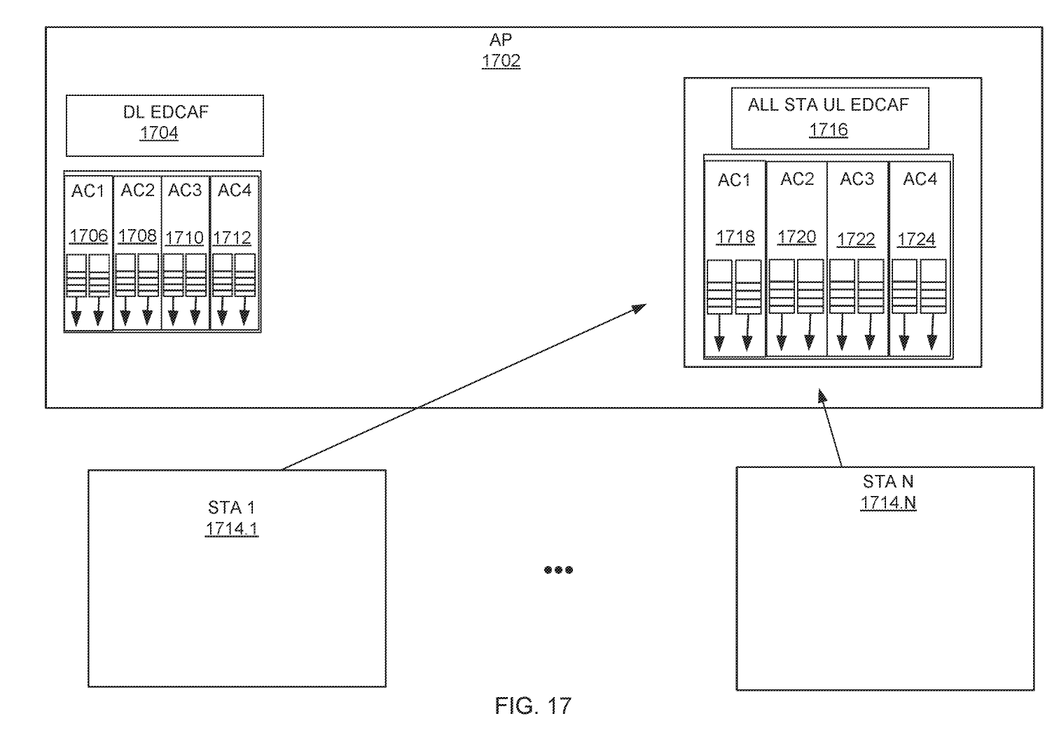

FIG. 17 illustrates a block diagram of an example of EDCAF for AP access for UL MU transmission in accordance with some embodiments. Illustrated in FIG. 17 is AP 1702 and STA 1 1714.1 through STA N 1714.N. The STA 1 1714.1 through STAN 1714.N may be associated with the AP 1702. The AP 1702 may be a master station 102. The STAs 1714 may be HE stations 106. The AP 1702 may determine whether the STAs 1714 are active based on, e.g., buffer status and information resource requests. The AP 1702 may maintain an All STA UL EDCAF 1716 for all active STAs 1714. The UL EDCAF is transferred from the STA 1 1714.1 through STA N 1714.N to the AP 1702. The AP 1702 may start All STA EDCAF 1716 to gain access to the wireless medium. In some embodiments, the AP 1702 may then serve the STA 1 1714.1 through STA N 1714.N in accordance with the AC1 1718, AC2 1720, AC3 1722, and AC4 1724. In some embodiments, the AP 1702 encodes a trigger frame (e.g., trigger frame 314) for the STAs 1714.

The AP 1702 may determine EDCA parameters, e,g, TXOP limit, a first CWmin, a CWmax, and a first AIFSN. In some embodiments, the AC 1702 determines the parameters as follows. CWmin=effective CWmin (number STAs in the queue (e.g., AC1 1718, AC2 1720, AC3 1722, and AC4 1724); CWmax=effective CWmax (e.g., AC1 1718, AC2 1720, AC3 1722, and AC4 1724); and, AIFS=effective AIFS (e.g., AC1 1718, AC2 1720, AC3 1722, and AC4 1724). The AP 1702 may determine the effective CWmin, CWmax, and AIFS based on the operation of the EDCA as described in conjunction with FIGS. 2 and 3. In some embodiments, the EDCA parameters are determined often based on the traffic into and out of the queues, e.g., AC1 1718, AC2 1720, AC3 1722, and AC4 1724. The frequency of updates to the EDCA parameters may be based on the active STAs buffer status information and resource requests.

In some embodiments, the AP 1702 may maintain ACs for DL data and start a EDCAF for gaining access to the wireless medium. The AP 1702 may determine the EDCA parameters for the EDCAF.

TABLE 3
SIMULATION OF EMBODIMENTS OF EDCAF

| | | | Case 3: 9 | Case 3: 18 |
|---|---|---|---|---|
| | Case 1 | Case 2 | Counters | Counters |
| AX BSS | 27.709 | 9.27 | 24.79 | 29.2 |
| (Mbps) | | | | |
| Legacy BSS | 34.21 | 52.62 | 22.29 | 13.45 |
| (Mbps) | | | | |

Table 3 illustrates simulation of embodiments of EDCAF. The simulation is performed with two BSSs as described in conjunction with FIG. 13. In case 1 the all the AP 1310.2 and the HE stations 104 use EDCA in accordance with the legacy BSS 1330.1.

In Case 2 the AP 1310.2 does all the UL MU for the HE stations 104 (e.g., send trigger frames with UL RUs). In Case 2, the throughput of the AX BSS (Mbps) is greater reduced from Case 1. Case 3 the AP 1310.2 maintains multiple EDCA counters. In Case 3: 9 EDCA counters, the AP 1310.2 maintains one EDCA counter per HE station 104 of the HE BSS 1330.2. In Case 3: 18 EDCA counters, the AP 1310.2 maintains two counters per HE station 104. Case 3: 9 counters restores the performance of the HE BSS 1330.2 to near Case 1 levels. Case 3: 18 counters exceeds the values of Case 1 and may not be fair to the legacy BSS 1330.

TABLE 4
SIMULATION OF EMBODIMENTS OF EDCAF

| | | | Case 3: 9 | Case 3: 18 | Case 3: 50 |
|---|---|---|---|---|---|
| | Case 1 | Case 2 | Counters | Counters | Counters |
| AX BSS | 5.8092 | 0.6168 | 1.4232 | 1.446 | 1.7316 |
| (Mbps) | | | | | |

Table 4 illustrates simulation of embodiments of EDCAF. The simulation is performed with eighteen legacy BSS 1430.1 through legacy BSS 1430.18 and one HE BSS 1432 as described in conjunction with FIG. 14.

In Case 1, the HE BSS 1432 uses EDCA in accordance with the legacy BSSs 1430. In Case 2, the HE AP (e.g, master station 102) of HE BSS 1432 uses one counter for the EDCAF, which results in a reduction in throughput to 0.61168 Mbps. In Case 3: 9 counters, the HE AP of HE BSS 1432 uses nine counters for the EDCAF, which results in improved performance over Case 2, but not up to Case 1 performance of 5.8092.

In Case 3: 18 counters, the HE AP of HE BSS 1432 uses 18 counters for the EDCAF, which results in slightly improved performance from the Case 3: 9 counters. In Case 3: 50 counters, the HE AP of HE BSS 1432 uses 50 counters for the EDCAF, which results in slightly improved performance from the Case 3: 18 counters.

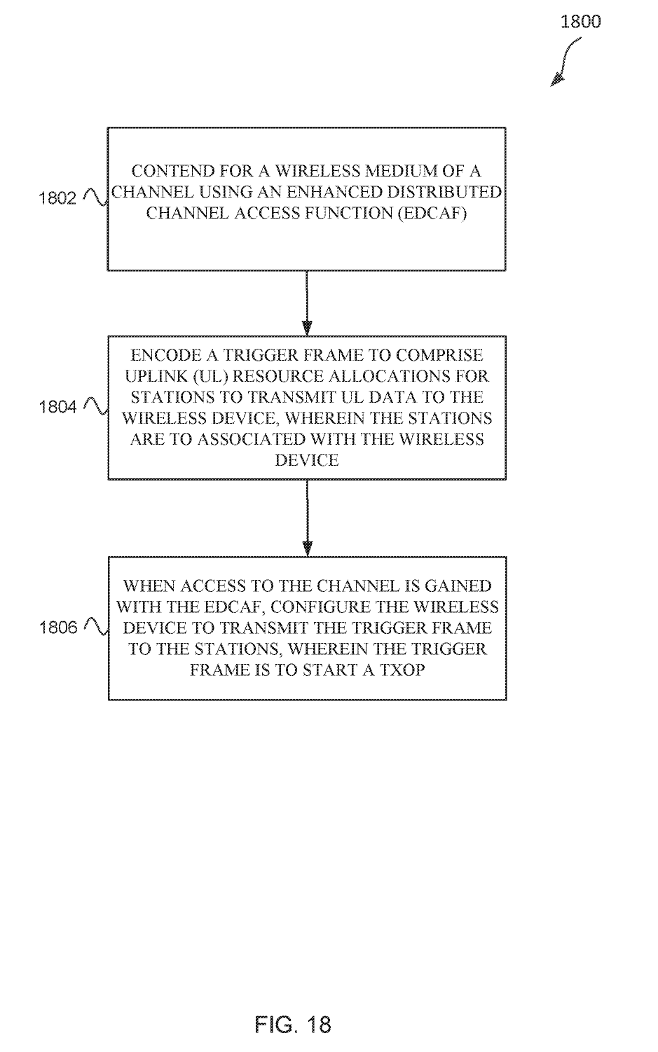

FIG. 18 illustrates a method 1800 of EDCAF for AP access for UL multi-user (MU) transmission in accordance with some embodiments. The method 1800 begins at operation 1802 with contending for a wireless medium of a channel using an EDCAF. For example, AP 1602 may contend for the wireless medium of a channel using STA 1 UL EDCAF 1616.1 through STA N UL EDCAF 1616. As another example, AP 1702 may contend for a wireless medium of a channel using the All STA UL EDCAF 1716. The wireless medium may be a portion of the wireless medium as described herein in conjunction with FIG. 1, in accordance with some embodiments. The AP 1602 and AP 1702 may be configure to contend for the wireless medium in accordance with the EDCA methods described in conjunction with FIG. 2.

The method 1800 may continue at operation 1804 with encoding a trigger frame to comprise UL resource allocations for stations to transmit UL data to the wireless device, where the stations are to associated with the wireless device. For example, AP 1602 may be configured to encode a trigger frame 314 which may include UL schedule 307 for resources for the STAs 306, where STAs 306 may be STA 1 1614.1 through STAN 1614.N. As another example, AP 1702 may be configured to encode a trigger frame 314 which may include UL schedule 307 for resources for the STAs 306.

The method 1800 may continue at operation 1806 with when access to the channel is gained with the EDCAF, configuring the wireless device to transmit the trigger frame to the stations, where the trigger frame is to start a TXOP.

For example, an apparatus of AP 1602 and AP 1702 may configure the APs to transmit the trigger frame to the STAs. The trigger frame may include a duration that begins a TXOP after a response to the trigger frame is received. The TXOP may be limited in duration based on EDCA parameters, e.g., TXOP limit.

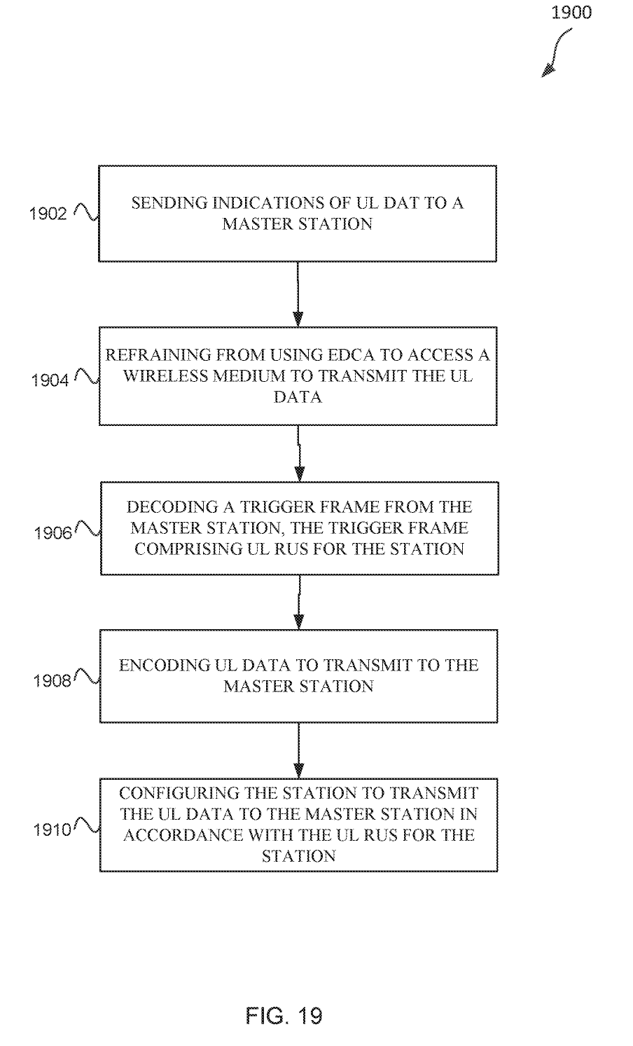

FIG. 19 illustrates a method 1900 of EDCAF for AP access for UL multi-user (MU) transmission in accordance with some embodiments. The method 1900 may begin at operation 1902 with sending indications of UL data to a master station. For example, referring to FIG. 3, STAs 306 may send UL data report 310 to the master station 102.

The method 1900 may continue at operation 1904 with refraining from using EDCA to access a wireless medium to transmit the UL data. For example, STA 1 1614.1 through STA N 1614.N may be configured to refrain from accessing the wireless medium for UL data when the AP 1602 is configured to access the wireless medium using STA 1 UL EDCAF 1616 through STA N UL EDCAF 1616.N for the corresponding STAs 1614. In another example, STA 1 1714.1 through STA N 1714.N may be configured to refrain from accessing the wireless medium when AP 1702 is configured to access the wireless medium using All STA UL EDCAF 1716.

The method 1900 may continue at operation 1906 with decoding a trigger frame from the master station, the trigger frame comprising UL RUs for the station. For example, referring to FIG. 3, master station 102 may transmit a trigger frame 314 to STAs 306. As another example, AP 1602 may transmit a trigger frame to one or more of STA 1 1614.1 through STA 1614.N with resource allocations for one or more of the STAs 1614. where the resource allocations may have been determined based on the ACs, e.g., AC1 1618, AC2 1620, AC3 1622, and AC4 1624.

The method 1900 may continue at operation 1908 with encoding UL data to transmit to the master station. For example, the stations indicated in the trigger frame may encode UL data for the master station. As another example, STAs 306 may encode UL data 312 for the master station 102. As another example, the selected STAB 1614 of STA 1 1614.1 through STA N 1614.N may encode UL data to send to the AP 1602. In another example, the selected STAs 1714 of STA 1 1714.1 through STA N 1714.N may encode UL data to send to the AP 1702.

The method 1900 may continue at operation 1910 with configuring the station to transmit the UL data to the master station in accordance with the UL RUs for the station. For example, an apparatus of STAs 306 may configure the STAs 306 to transmit GL data 312 to master station 102. As another example, an apparatus of each of the selected STAs 1614 of STA 1 1614.1 through STA N 1614.N may configure the correspond STA 1614 to transmit UL data to the AP 1602. As another example, an apparatus of each of the selected STAs 1614 of STA 1 1614.1 through STA N 1614.N may configure the correspond STA 1614 to transmit UI, data to the AP 1602.

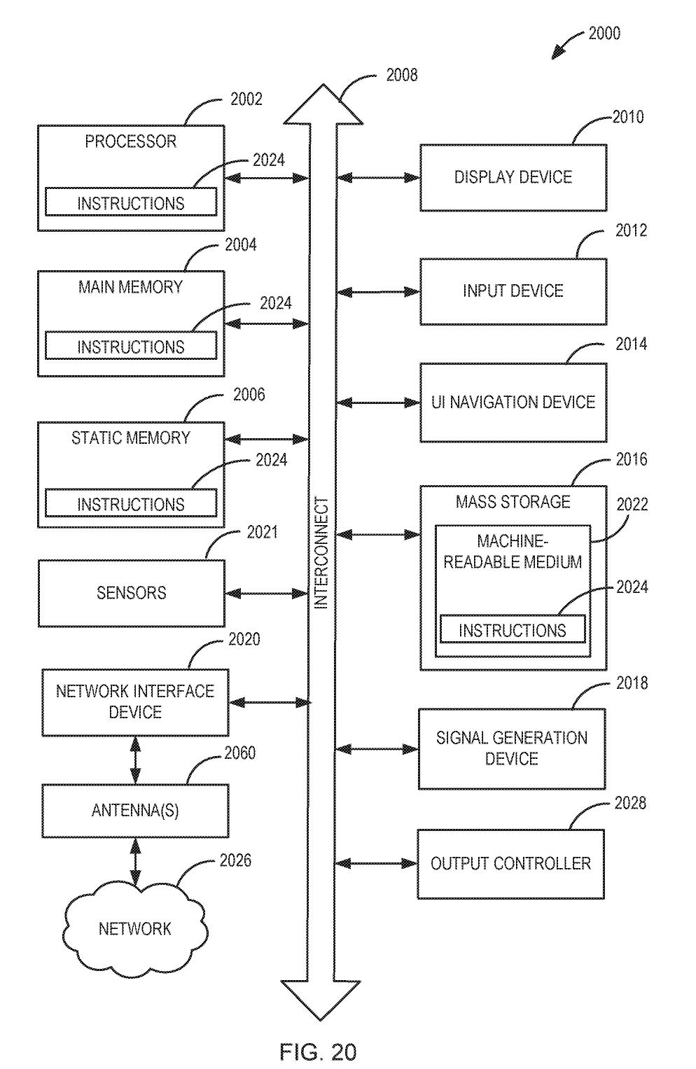

FIG. 20 illustrates a block diagram of an example machine 2000 upon which any one or more of the techniques (e.g., methodologies) discussed herein may perform, in accordance with some embodiments. In alternative embodiments, the machine 2000 may operate as a standalone device or may be connected (e.g., networked) to other machines. In a networked deployment, the machine 2000 may operate in the capacity of a server machine, a client machine, or both in server-client network environments. In an example, the machine 2000 may act as a peer machine in peer-to-peer (P2P) (or other distributed) network environment. The machine 2000 may be a master station 102, HE station 104, personal computer (PC), a tablet PC, a set-top box (STB), a personal digital assistant (PDA), a mobile telephone, a smart phone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate on, logic or a number of components, modules, or mechanisms. Modules are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

Machine (e.g., computer system) 2000 may include a hardware processor 2002 (e.g., a central processing unit (CPU), a graphics processing unit (GPU), a hardware processor core, or any combination thereof), a main memory 2004 and a static memory 2006, some or all of which may communicate with each other via an interlink (e.g., bus) 2008. The machine 2000 may further include a display device 2010, an input device 2012 (e.g., a keyboard), and a user interface (UI) navigation device 2014 (e.g., a mouse). In an example, the display device 2010, input device 2012 and UI navigation device 2014 may be a touch screen display. The machine 2000 may additionally include a mass storage (e.g., drive unit) 2016, a signal generation device 2018 (e.g., a speaker), a network interface device 2020, and one or more sensors 2021, such as a global positioning system (GPS) sensor, compass, accelerometer, or other sensor. The machine 2000 may include an output controller 2028, such as a serial (e.g., universal serial bus (USB), parallel, or other wired or wireless (e.g., infrared(IR), near field communication (NFC), etc.) connection to communicate or control one or more peripheral devices (e.g., a printer, card reader, etc.). In some embodiments the processor 2002 and/or instructions 2024 may comprise processing circuitry and/or transceiver circuitry.

The storage device 2016 may include a machine readable medium 2022 on which is stored one or more sets of data structures or instructions 2024 software) embodying or utilized by any one or more of the techniques or functions described herein. The instructions 2024 may also reside, completely or at least partially, within the main memory 2004, within static memory 2006, or within the hardware processor 2002 during execution thereof by the machine 2000. In an example, one or any combination of the hardware processor 2002, the main memory 2004, the static memory 2006, or the storage device 2016 may constitute machine readable media.

While the machine readable medium 2022 is illustrated as a single medium, the term “machine readable medium” may include a single medium or multiple media (e.g., a centralized or distributed database, and/or associated caches and servers) configured to store the one or more instructions 2024.

An apparatus of the machine 2000 may be one or more of a hardware processor 2002 (e.g., a central processing unit (CPU), a graphics processing unit (GPU), a hardware processor core, or any combination thereof), a main memory 2004 and a static memory 2006, some or all of which may communicate with each other via an interlink (e.g., bus) 2008.

The term “machine readable medium” may include any medium that is capable of storing, encoding, or carrying instructions for execution by the machine 2000 and that cause the machine 2000 to perform any one or more of the techniques of the present disclosure, or that is capable of storing, encoding or carrying data structures used by or associated with such instructions. Non-limiting machine readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); and CD-ROM and DVD-ROM disks. In some examples, machine readable media may include non-transitory machine readable media. In some examples, machine readable media may include machine readable media that is not a transitory propagating signal.

The instructions 2024 may further be transmitted or received over a communications network 2026 using a transmission medium via the network interface device 2020 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, a Long Term Evolution (LTE) family of standards, a Universal Mobile Telecommunications System (UMTS) family of standards, peer-to-peer (P2P) networks, among others.

In an example, the network interface device 2020 may include one or more physical jacks (e.g., Ethernet, coaxial, or phone jacks) or one or more antennas to connect to the communications network 2026. In an example, the network interface device 2020 may include one or more antennas 2060 to wirelessly communicate using at least one of single-input multiple-output (SIMO), multiple-input multiple-output (MIMO), or multiple-input single-output (MISO) techniques. In some examples, the network interface device 2020 may wirelessly communicate using Multiple User MIMO techniques. The term “transmission medium” shall be taken to include any intangible medium that is capable of storing, encoding or carrying instructions for execution by the machine 2000, and includes digital or analog communications signals or other intangible medium to facilitate communication of such software.

Various embodiments may be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM) magnetic disk storage media; optical storage media; flash memory, etc.

The following examples pertain to further embodiments. Example 1 is an apparatus of a wireless device, the apparatus including: memory; and processing circuitry coupled to the memory, the processing circuity configured to: contend for access to a wireless medium of a channel with a first access category (AC), where the first AC comprises a first transmission opportunity (TXOP) limit, a first contention window minimum (CWmin), a first contention window maximum (CWmax), and a first arbitration inter-frame space (AIFS) number (AIFSN), and where the contend is to be in accordance with the first CWmin, the first CWmax, and the first AIFSN; assign a second AC to a trigger frame; encode the trigger frame to comprise resource allocations for stations, the second AC to indicate to the stations a type of data to transmit in the resource allocations; and when access to the channel is gained with the first AC, configure the wireless device to transmit the trigger frame to the stations, where the trigger frame is to start a TXOP with the first TXOP limit.

In Example 2, the subject matter of Example 1 optionally includes where the first AC is the same as the second AC.

In Example 3, the subject matter of any one or more of Examples 1-2 optionally include where the first AC and the second AC are each one from the following group: AC video, AC voice, AC best effort, AC background, and AC trigger frame.

In Example 4, the subject matter of any one or more of Examples 1-3 optionally include where the processing circuitry is further configured to: contend for access to a wireless medium of a channel with enhanced distributed channel access functions (EDCAFs) with one or more additional ACs to transmit the trigger frame.

In Example 5, the subject matter of Example 4 optionally includes where the processing circuitry is further configured to: assign an AC that first wins access to the channel to the second AC.

In Example 6, the subject matter of any one or more of Examples 1-5 optionally include where the first AC further comprises a first contention window minimum (CWmin), a first contention window maximum (CWmax), and a first arbitration inter-frame space (AIFS) number (AIFSN).

In Example 7, the subject matter of any one or more of Examples 1-6 optionally include where the processing circuitry is further configured to: if the transmission of the trigger frame is not successful, contend for access to the wireless medium of the channel with the first AC a second time; and configure the wireless device to re-transmit the trigger frame to the stations, where the trigger frame is to start the TXOP with the first TXOP limit.

In Example 8, the subject matter of any one or more of Examples 1-7 optionally include where the processing circuitry is further configured to: contend for the access to the wireless medium of the channel in accordance with enhanced distributed channel access (EDCA).

In Example 9, the subject matter of any one or more of Examples 1-8 optionally include where the first AC and the second AC are a trigger frame (IF) AC; and the processing circuitry is further configured to: determine at least one of a TF AC TXOP limit, a TF AC CWmin, a TF AC CWmax, and a TF AC AIFSN.

In Example 10, the subject matter of Example 9 optionally includes where the determination is based on one or both of an amount of downlink data for the stations and an amount of uplink data residing at the stations.

In Example 11, the subject matter of any one or more of Examples 9-10 optionally include where the processing circuitry is further configured to: encode a frame including an indication of the TF AC TXOP limit, the TF AC CWmin, the TF AC CWmax, and the TF AC AIFSN; and configure the wireless device to transmit the frame.

In Example 12, the subject matter of any one or more of Examples 1-11 optionally include where the first AC and the second AC are a trigger frame (TF) AC; and the processing circuitry is further configured to: decode a frame including a second TF AC TXOP limit, a second TF AC CWmin, a second TF AC CWmax, and a second TF AC AIFSN, where the frame is to be received from a neighboring wireless device; and determine at least one of a TF AC TXOP limit, a TF AC CWmin, a TF AC CWmax, and a TF AC AIFSN based on the second TF AC TXOP limit, the second TF AC SWmin, the second TF AC CWmax, and the second TF AC AIFSN.

In Example 13, the subject matter of any one or more of Examples 1-12 optionally include where the processing circuitry is further configured to: encode a second trigger frame; and configure the wireless device to transmit the second trigger frame after a fixed duration from a previous frame, where the previous frame is either a frame to be received from a station or a frame to be transmitted to by the wireless device.

In Example 14, the subject matter of any one or more of Examples 1-13 optionally include where the processing circuitry is further configured to: store indications of downlink (DL) data in DL queues for each associated station of the stations; and store indications of uplink (UL) data in UL queues for each associated station of the stations.

In Example 15, the subject matter of any one or more of Examples 1-14 optionally include where the processing circuitry is further configured to: store indications of downlink (DL) data in DL queues for each associated station of the stations and for each traffic identification (TID) of a plurality of TIDs; and store indications of uplink (UL) data in UL queues for each associated station of the stations and for each TIDs of a plurality of TIDs.

In Example 16, the subject matter of any one or more of Examples 1-15 optionally include where the processing circuitry is further configured to: store indications of downlink (DL) data in DL queues for each associated station of the stations and for each AC of a plurality of ACs; and store indications of uplink (UL) data in UL queues for each associated station of the stations and for each AC of a plurality of ACs.

In Example 17, the subject matter of Example 16 optionally includes where the processing circuitry is further configured to: contend for the wireless medium of the channel using start enhanced distributed channel access functions (EDCAFs) for each of the ACs of the plurality of ACs for uplink (UL) and for downlink (DL); and for a first EDCAF to gain access to the wireless medium, encode a second frame for the corresponding AC of the UL or the DL of the first EDCAF to gain access to the wireless medium, where the second frame is to comprise DL resource allocations for the DL queues of the corresponding AC and resource allocations for the UL queues for the corresponding AC.

In Example 18, the subject matter of any one or more of Examples 16-17 optionally include where the processing circuitry is further configured to: start enhanced distributed channel access functions (EDCAFs) to contend for the wireless medium of the channel for uplink (UL) and for downlink (DL); and for a first EDCAF to gain access to the wireless medium, encode a second frame for the UL or the DL of the first EDCAF to gain access to the wireless medium, where the second frame is to comprise DL resource allocations for the DL queues or the UL queues.

In Example 19, the subject matter of any one or more of Examples 1-18 optionally include where the processing circuitry is further configured to: encode the trigger frame to comprise resource allocation for stations, where the trigger frame comprises (UL) resource allocations.

In Example 20, the subject matter of any one or more of Examples 1-19 optionally include where the second AC comprises a second TXOP limit, a second CWmin, a second CWmax, and a second AIFSN.

In Example 21, the subject matter of any one or more of Examples 1-20 optionally include where the wireless device and the stations are each one from the following group: an Institute of Electrical and Electronic Engineers (IEEE) 21 is missing parent: 21 is missing parent: 802.11ax access point, an IEEE 802.11ax station, an IEEE 21 is missing parent: 21 is missing parent: 802.11 station, and an IEEE 802.11 access point.

In Example 22, the subject matter of any one or more of Examples 1-21 optionally include transceiver circuitry coupled to the processing circuitry.

Example 23 is a non-transitory computer-readable storage medium that stores instructions for execution by one or more processors, the instructions to configure the one or more processors to cause a wireless device to: contend for access to a wireless medium of a channel with a first access category (AC), where the first AC comprises a first transmission opportunity (TXOP) limit, a first contention window minimum (CWmin), a first contention window maximum (CWmax), and a first arbitration inter-frame space (AIFS) number (AIFSN), and where the contend is to be in accordance with the first CWmin, the first CWmax, and the first AIFSN; assign a second AC to a trigger frame; encode the trigger frame to comprise resource allocations for stations, the second AC to indicate to the stations a type of data to transmit in the resource allocations; and when access to the channel is gained with the first AC, configure the wireless device to transmit the trigger frame to the stations, where the trigger frame is to start a TXOP with the first TXOP limit.

In Example 24, the subject matter of Example 23 optionally includes where the first AC and the second AC are each one from the following group: AC video, AC voice, AC best effort, AC background, and AC trigger frame.

Example 25 is a method performed by a wireless device, the method including: contending for access to a wireless medium of a channel with a first access category (AC), where the first AC comprises a first transmission opportunity (TXOP) limit, a first contention window minimum (CWmin), a first contention window maximum (CWmax), and a first arbitration inter-frame space (AIFS) number (AIFSN), and where the contend is to be in accordance with the first CWmin, the first CWmax, and the first AIFSN; assigning a second AC to a trigger frame; encoding the trigger frame to comprise resource allocations for stations, the second AC to indicate to the stations a type of data to transmit in the resource allocations; and when access to the channel is gained with the first AC, configuring the wireless device to transmit the trigger frame to the stations, where the trigger frame is to start a TXOP with the first TXOP limit.

In Example 26, the subject matter of Example 25 optionally includes where the first AC and the second AC are each one from the following group: AC video, AC voice, AC best effort, AC background, and AC trigger frame.

Example 27 is an apparatus of a station including: memory; and processing circuitry coupled to the memory, the processing circuity configured to: decode a trigger frame including an uplink (UL) resource allocation for the station and an indication of an access category (AC); select data to transmit based on the AC; encode a frame including the selected data; and configure the station to transmit the frame in accordance with the UL resource allocation.

In Example 28, the subject matter of Example 27 optionally includes where the processing circuitry is further configured to: select the data with the AC first, and then select data with an AC with a higher priority than the AC.

In Example 29, the subject matter of any one or more of Examples 27-28 optionally include transceiver circuitry coupled to the processing circuitry.

Example 30 is an apparatus of a wireless device, the apparatus including: means for contending for access to a wireless medium of a channel with a first access category (AC), where the first AC comprises a first transmission opportunity (TXOP) limit, a first contention window minimum (CWmin), a first contention window maximum (CWmax), and a first arbitration inter-frame space (AIFS) number (AIFSN), and where the contend is to be in accordance with the first CWmin, the first CWmax, and the first AIFSN; means for assigning a second AC to a trigger frame; means for encoding the trigger frame to comprise resource allocations for stations, the second AC to indicate to the stations a type of data to transmit in the resource allocations; and when access to the channel is gained with the first AC, means for configuring the wireless device to transmit the trigger frame to the stations, where the trigger frame is to start a TXOP with the first TXOP limit.

In Example 31, the subject matter of Example 30 optionally includes where the first AC is the same as the second AC.

In Example 32, the subject matter of any one or more of Examples 30-31 optionally include where the first AC and the second AC are each one from the following group: AC video, AC voice, AC best effort, AC background, and AC trigger frame.

In Example 33, the subject matter of any one or more of Examples 30-32 optionally include means for contending for access to a wireless medium of a channel with enhanced distributed channel access functions (EDCAFs) with one or more additional ACs to transmit the trigger frame.

In Example 34, the subject matter of Example 33 optionally includes means for assigning an AC that first wins access to the channel to the second AC.

In Example 35, the subject matter of any one or more of Examples 30-34 optionally include where the first AC further comprises a first contention window minimum (CWmin), a first contention window maximum (CWmax), and a first arbitration inter-frame space (AIFS) number (AIFSN).

In Example 36, the subject matter of any one or more of Examples 1-35 optionally include if the transmission of the trigger frame is not successful, means for contending for access to the wireless medium of the channel with the first AC a second time; and means for configuring the wireless device to retransmit the trigger frame to the stations, where the trigger frame is to start the TXOP with the first TXOP limit.

In Example 37, the subject matter of any one or more of Examples 1-36 optionally include means for contending for the access to the wireless medium of the channel in accordance with enhanced distributed channel access (EDCA).

In Example 38, the subject matter of any one or more of Examples 1-37 optionally include where the first AC and the second AC are a trigger frame (TF) AC; and further including: means for determining at least one of a TF AC TXOP limit, a TF AC CWmin, a TF AC CWmax, and a TF AC AIFSN.

In Example 39, the subject matter of Example 38 optionally includes where the determination is based on one or both of an amount of downlink data for the stations and an amount of uplink data residing at the stations.

In Example 40, the subject matter of Example 39 optionally includes means for encoding a frame including an indication of the TF AC TXOP limit, the TF AC CWmin, the TF AC CWmax, and the TF AC AIFSN; and means for configuring the wireless device to transmit the frame.

In Example 41, the subject matter of any one or more of Examples 30-40 optionally include where the first AC and the second AC are a trigger frame (TF) AC; and further including: means for decoding a frame including a second TF AC TXOP limit, a second TF AC CWmin, a second TF AC CWmax, and a second TF AC AIFSN, where the frame is to be received from a neighboring wireless device; and means for determining at least one of a TF AC TXOP limit, a TF AC CWmin, a TF AC CWmax, and a TF AC AIFSN based on the second TF AC TXOP limit, the second TF AC SWmin, the second TF AC CWinax, and the second TF AC AIFSN.

In Example 42, the subject matter of any one or more of Examples 30-41 optionally include means for encoding a second trigger frame; and means for configuring the wireless device to transmit the second trigger frame after a fixed duration from a previous frame, where the previous frame is either a frame to be received from a station or a frame to be transmitted to by the wireless device.

In Example 43, the subject matter of any one or more of Examples 30-42 optionally include means for storing indications of downlink (DL) data in DL queues for each associated station of the stations; and means for storing indications of uplink (UL) data in UL queues for each associated station of the stations.

In Example 44, the subject matter of any one or more of Examples 30-43 optionally include means for storing indications of downlink (DL) data in DL queues for each associated station of the stations and for each traffic identification (TID) of a plurality of TIDs; and means for storing indications of uplink (UL) data in UL queues for each associated station of the stations and for each TIDs of a plurality of TIDs.

In Example 45, the subject matter of any one or more of Examples 30-44 optionally include means for storing indications of downlink (DL) data in DL queues for each associated station of the stations and for each AC of a plurality of ACs; and means for storing indications of uplink (UL) data in UL queues for each associated station of the stations and for each AC of a plurality of ACs.

In Example 46, the subject matter of Example 45 optionally includes means for contending for the wireless medium of the channel using start enhanced distributed channel access functions (EDCAFs) for each of the ACs of the plurality of ACs for uplink (UL) and for downlink (DL); and for a first EDCAF to gain access to the wireless medium, means for encoding a second frame for the corresponding AC of the UL or the DL of the first EDCAF to gain access to the wireless medium, where the second frame is to comprise DL resource allocations for the DL queues of the corresponding AC and resource allocations for the UL queues for the corresponding AC.

In Example 47, the subject matter of Example 46 optionally includes means for starting enhanced distributed channel access functions (EDCAFs) to contend for the wireless medium of the channel for uplink (UL) and for downlink (DL); and for a first EDCAF to gain access to the wireless medium, means for encoding a second frame for the UL or the DL of the first EDCAF to gain access to the wireless medium, where the second frame is to comprise DL resource allocations for the DL queues or the UL queues.

In Example 48, the subject matter of any one or more of Examples 30-47 optionally include means for encoding the trigger frame to comprise resource allocation for stations, where the trigger frame comprises (UL) resource allocations.

In Example 49, the subject matter of any one or more of Examples 30-48 optionally include where the second AC comprises a second TXOP limit, a second CWmin, a second CWmax, and a second AIFSN.

In Example 50, the subject matter of any one or more of Examples 30-49 optionally include where the wireless device and the stations are each one from the following group: an Institute of Electrical and Electronic Engineers (IEEE) 50 is missing parent: 50 is missing parent: 802.11ax access point, an IEEE 802.11ax station, an IEEE 50 is missing parent: 50 is missing parent: 802.11 station, and an IEEE 802.11 access point.

In Example 51, the subject matter of any one or more of Examples 30-50 optionally include means for transmitting and receiving radio waves.

Example 52 is a non-transitory computer-readable storage medium that stores instructions for execution by one or more processors, the instructions to configure the one or more processors to cause a wireless device to: decode a trigger frame including an uplink (UL) resource allocation for the station and an indication of an access category (AC); select data to transmit based on the AC; encode a frame including the selected data; and configure the station to transmit the frame in accordance with the UL resource allocation.

In Example 53, the subject matter of Example 52 optionally includes where the instructions further configure the one or more processors to cause the wireless device to: select the data with the AC first, and then select data with an AC with a higher priority than the AC.

Example 54 is a method performed by an apparatus of a wireless device, the method including: decoding a trigger frame including an uplink (UL) resource allocation for the station and an indication of an access category (AC); selecting data to transmit based on the AC; encoding a frame including the selected data; and configuring the station to transmit the frame in accordance with the UL resource allocation.

in Example 55, the subject matter of Example 54 optionally includes the method further including: selecting the data with the AC first, and then select data with an AC with a higher priority than the AC.

Example 56 is a apparatus of a wireless device, the apparatus including: means for decoding a trigger frame including an uplink (UL) resource allocation for the station and an indication of an access category (AC); means for selecting data to transmit based on the AC; means for encoding a frame including the selected data; and means for configuring the station to transmit the frame in accordance with the UL resource allocation.

In Example 57, the subject matter of Example 56 optionally includes the apparatus further including: means for selecting the data with the AC first, and then select data with an AC with a higher priority than the AC.

Example 58 is an apparatus of a wireless device including: memory; and processing circuitry coupled to the memory, the processing circuity configured to: contend for a wireless medium of a channel using an enhanced distributed channel access (EDCA) function (EDCAF); encode a trigger frame to comprise uplink (UL) resource allocations for stations to transmit UL data to the wireless device, where the stations are to be associated with the wireless device; and when access to the channel is gained with the EDCAF, configure the wireless device to transmit the trigger frame to the stations, where the trigger frame is to start a transmission opportunity (TXOP).

In Example 59, the subject matter of Example 58 optionally includes where the processing circuitry is further configured to: contend for the wireless medium of the channel using the EDCAF and additional EDCAFs, where one EDCAF is to be used for each station associated with the wireless device.

In Example 60, the subject matter of Example 59 optionally includes where the processing circuitry is further configured to: if two EDCAFs gain access to the wireless medium at a same time, select one of the two EDCAFs based on a priority of download traffic for a corresponding station associated with the wireless device.

In Example 61, the subject matter of any one or more of Examples 58-60 optionally include where the processing circuitry is further configured to: contend for the wireless medium of the channel using the EDCAF, where the EDCAF is to include multiple counters to contend for the wireless medium.

In Example 62, the subject matter of Example 61 optionally includes where the processing circuitry is further configured to: determine a number of the multiple counters based on a number of active stations associated with the wireless device.

In Example 63, the subject matter of any one or more of Examples 58-62 optionally include where the processing circuitry is further configured to: store indications of uplink (UL) data in UL queues for each associated station; and determine parameters for the EDCAF to contend for the wireless medium based on a number of stations in the UL queues, the parameters including one or more of the following group: a contention window minimum, a contention window maximum, and an arbitration inter-frame space (AIFS) number (AIFSN).

In Example 64, the subject matter of Example 63 optionally includes where an indication of UL data comprises resource allocation requests from the stations.

In Example 65, the subject matter of any one or more of Examples 63-64 optionally include where the processing circuitry is further configured to: contend for the wireless medium of the channel using EDCAF in accordance with EDCA parameters for the stations.

In Example 66, the subject matter of any one or more of Examples 63-65 optionally include transceiver circuitry coupled to the processing circuitry.

Example 67 is a non-transitory computer-readable storage medium that stores instructions for execution by one or more processors, the instructions to configure the one or more processors to cause a wireless device to: contend for a wireless medium of a channel using an enhanced distributed channel access (EDCA) function (EDCAF); encode a trigger frame to comprise uplink (EL) resource allocations for stations to transmit EL data to the wireless device, where the stations are to be associated with the wireless device: and when access to the channel is gained with the EDCAF, configure the wireless device to transmit the trigger frame to the stations, where the trigger frame is to start a transmission opportunity (TXOP).

In Example 68, the subject matter of Example 67 optionally includes where the instructions further configure the one or more processors to cause the wireless device to: contend for the wireless medium of the channel using the EDCAF and additional EDCAFs, where one EDCAF is to be used for each station associated with the wireless device.

In Example 69, the subject matter of any one or more of Examples 67-68 optionally include where the instructions further configure the one or more processors to cause the wireless device to: if two EDCAFs gain access to the wireless medium at a same time, select one of the two EDCAFs based on a priority of download traffic for a corresponding station associated with the wireless device.

In Example 70, the subject matter of any one or more of Examples 67-69 optionally include where the instructions further configure the one or more processors to cause the wireless device to: contend for the wireless medium of the channel using the EDCAF, where the EDCAF is to include multiple counters to contend for the wireless medium.

In Example 71, the subject matter of Example 70 optionally includes where the instructions further configure the one or more processors to cause the wireless device to: determine a number of the multiple counters based on a number of active stations associated with the wireless device.

In Example 72, the subject matter of any one or more of Examples 67-71 optionally include where the instructions further configure the one or more processors to cause the wireless device to: store indications of uplink (UL) data in UL queues for each associated station; and determine parameters for the EDCAF to contend for the wireless medium based on a number of stations in the UL queues, the parameters including one or more of the following group: a contention window minimum, a contention window maximum, and an arbitration inter-frame space (AIFS) number (AIFSN).

In Example 73, the subject matter of any one or more of Examples 67-72 optionally include where the instructions further configure the one or more processors to cause the wireless device to: contend for the wireless medium of the channel using EDCAF in accordance with EDCA parameters for the stations.

Example 74 is a method performed by an apparatus of a wireless device, the method including: contending for a wireless medium of a channel using an enhanced distributed channel access (EDCA) function (EDCAF); encoding a trigger frame to comprise uplink (UL) resource allocations for stations to transmit UL data to the wireless device, where the stations are to be associated with the wireless device; and when access to the channel is gained with the EDCAF, configuring the wireless device to transmit the trigger frame to the stations, where the trigger frame is to start a transmission opportunity (TXOP).

In Example 75, the subject matter of Example 74 optionally includes the method further including: contending for the wireless medium of the channel using the EDCAF and additional EDCAFs, where one EDCAF is to be used for each station associated with the wireless device.

In Example 76, the subject matter of any one or more of Examples 74-75 optionally include the method further including: if two EDCAFs gain access to the wireless medium at a same time, selecting one of the two EDCAFs based on a priority of download traffic for a corresponding station associated with the wireless device.

In Example 77, the subject matter of any one or more of Examples 74-76 optionally include the method further including: contending for the wireless medium of the channel using the EDCAF, where the EDCAF is to include multiple counters to contend for the wireless medium.

In Example 78, the subject matter of any one or more of Examples 74-77 optionally include the method further including: determining a number of the multiple counters based on a number of active stations associated with the wireless device.

In Example 79, the subject matter of any one or more of Examples 74-78 optionally include the method further including: storing indications of uplink (UL) data in UL queues for each associated station; and determining parameters for the EDCAF to contend for the wireless medium based on a number of stations in the UL queues, the parameters including one or more of the following group: a contention window minimum, a contention window maximum, and an arbitration inter-frame space (AIFS) number (AIFSN).

In Example 80, the subject matter of any one or more of Examples 74-79 optionally include the method further including: contending for the wireless medium of the channel using EDCAF in accordance with EDCA parameters for the stations.

Example 81 is an apparatus of a wireless device, the apparatus including: means for contending for a wireless medium of a channel using an enhanced distributed channel access (EDCA) function (EDCAF); means for encoding a trigger frame to comprise uplink (UL) resource allocations for stations to transmit UL data to the wireless device, where the stations are to be associated with the wireless device; and when access to the channel is gained with the EDCAF, means for configuring the wireless device to transmit the trigger frame to the stations, where the trigger frame is to start a transmission opportunity (TXOP).

In Example 82, the subject matter of Example 81 optionally includes the apparatus further including: means for contending for the wireless medium of the channel using the EDCAF and additional EDCAFs, where one EDCAF is to be used for each station associated with the wireless device.

In Example 83, the subject matter of any one or more of Examples 81-82 optionally include the apparatus further including: if two EDCAFs gain access to the wireless medium at a same time, means for selecting one of the two EDCAFs based on a priority of download traffic for a corresponding station associated with the wireless device.

In Example 84, the subject matter of any one or more of Examples 81-83 optionally include the apparatus further including: means for contending for the wireless medium of the channel using the EDCAF, where the EDCAF is to include multiple counters to contend for the wireless medium.

In Example 85, the subject matter of any one or more of Examples 81-84 optionally include the apparatus further including: means for determining a number of the multiple counters based on a number of active stations associated with the wireless device.

In Example 86, the subject matter of any one or more of Examples 81-85 optionally include the apparatus further including: means for storing indications of uplink (UL) data in UL queues for each associated station; and means for determining parameters for the EDCAF to contend for the wireless medium based on a number of stations in the UL queues, the parameters including one or more of the following group: a contention window minimum, a contention window maximum, and an arbitration inter-frame space (AIFS) number (AIFSN).

In Example 87, the subject matter of any one or more of Examples 81-86 optionally include the apparatus further including: means for contending for the wireless medium of the channel using EDCAF in accordance with EDCA parameters for the stations.

Example 88 is a method performed by an apparatus of a station, the method including: sending indications of UL data to a master station; refraining from using EDCA to access a wireless medium to transmit the UL data; decoding a trigger frame from the master station, the trigger frame including UL RUs for the station; encoding UL data to transmit to the master station; and configuring the station to transmit the UL data to the master station in accordance with the UL RUs for the station.

In Example 89, the subject matter of Example 88 optionally includes the method fluffier including: configuring the stations to transmit resource requests to the master station for UL RUs for the station.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

What is claimed is:

1. An apparatus of a wireless device, the apparatus comprising:
memory; and processing circuitry coupled to the memory, the processing circuity configured to:
contend for access to a wireless medium of a channel with a first access category (AC), wherein the first AC comprises a first transmission opportunity (TXOP) limit, a first contention window minimum (CWmin), a first contention window maximum (CWmax), and a first arbitration inter-frame space (AIFS) number (AIFSN), and wherein the contend is to be in accordance with the first CWmin, the first CWmax, and the first AIFSN;
assign a second AC to a trigger frame;
encode the trigger frame to comprise resource allocations for stations, the second AC to indicate to the stations a type of data to transmit in the resource allocations; and
when access to the channel is gained with the first AC, configure the wireless device to transmit the trigger frame to the stations, wherein the trigger frame is to start a TXOP with the first TXOP limit.

2. The apparatus of claim 1, wherein the first AC is the same as the second AC.

3. The apparatus of claim 1, wherein the first AC and the second AC are each one from the following group: AC video, AC voice, AC best effort, AC background, and AC trigger frame.

4. The apparatus of claims 1, wherein the processing circuitry is further configured to:
contend for access to a wireless medium of a channel with enhanced distributed channel access functions (EDCAFs) with one or more additional ACs to transmit the trigger frame.

5. The apparatus of claim 4, wherein the processing circuitry is further configured to:
assign an AC that first wins access to the channel to the second AC.

6. The apparatus of claim 1, wherein the first AC further comprises a first contention window minimum (CWmin), a first contention window maximum (CWmax), and a first arbitration inter-frame space (AIFS) number (AIFSN).

7. The apparatus of claim 1, wherein the processing circuitry is further configured to:
if the transmission of the trigger frame is not successful, contend for access to the wireless medium of the channel with the first AC a second time; and
configure the wireless device to re-transmit the trigger frame to the stations, wherein the trigger frame is to start the TXOP with the first TXOP limit.

8. The apparatus of claim 1, wherein the processing circuitry is further configured to:
contend for the access to the wireless medium of the channel in accordance with enhanced distributed channel access (EDCA).

9. The apparatus of claim 1, wherein the first AC and the second AC are a trigger frame (TF) AC; and the processing circuitry is further configured to:
determine at least one of a TF AC TXOP limit, a TF AC CWmin, a TF AC CWmax, and a TF AC AIFSN.

10. The apparatus of claim 9, wherein the determination is based on one or both of an amount of downlink data for the stations and an amount of uplink data residing at the stations.

11. The apparatus of claim 9, wherein the processing circuitry is further configured to:
encode a frame comprising an indication of the TF AC TXOP limit, the TF AC CWmin, the TF AC CWmax, and the TF AC AIFSN; and
configure the wireless device to transmit the frame.

12. The apparatus of claim 1, wherein the first AC and the second AC are a trigger frame (TF) AC; and the processing circuitry is further configured to:
decode a frame comprising a second TF AC TXOP limit, a second TF AC CWmin, a second TF AC CWmax, and a second TF AC AIFSN, wherein the frame is to be received from a neighboring wireless device; and
determine at least one of a TF AC TXOP limit, a TF AC CWmin, a TF AC CWmax, and a TF AC AIFSN based on the second TF AC TXOP the second TF AC SWmin, the second TF AC CWmax, and the second TF AC AIFSN.

13. The apparatus of claim 1, wherein the processing circuitry is further configured to:
store indications of downlink (DL) data in DL queues for each associated station of the stations; and
store indications of uplink data in UL queues for each associated station of the stations.

14. The apparatus of claim 1, wherein the processing circuitry is further configured to:
contend for the wireless medium of the channel using start enhanced distributed channel access functions (EDCAFs) for each of the ACs of the plurality of ACs for uplink (UL) and for downlink (DL); and
for a first EDCAF to gain access to the wireless medium, encode a second frame for the corresponding AC of the UL or the DL of the first EDCAF to gain access to the wireless medium, wherein the second frame is to comprise DL resource allocations for the DL queues of the corresponding AC and resource allocations for the UL queues for the corresponding AC.

15. The apparatus of claim 1, wherein the processing circuitry is further configured to:
encode the trigger frame to comprise resource allocation for stations, wherein the trigger frame comprises (UL) resource allocations.

16. The apparatus of claim 1, wherein the wireless device and the stations are each one from the following group: an Institute of Electrical and Electronic Engineers (IEEE) 802.11ax access point, an IEEE 802.11ax station, an IEEE 802.11 station, and an IEEE 802.11 access point.

17. The apparatus of claim 1, further comprising: transceiver circuitry coupled to the processing circuitry.

18. A non-transitory computer-readable storage medium that stores instructions for execution by one or more processors, the instructions to configure the one or more processors to cause a wireless device to:
contend for access to a wireless medium of a channel with a first access category (AC), wherein the first AC comprises a first transmission opportunity (TXOP) limit, a first contention window minimum (CWmin), a first contention window maximum (CWmax), and a first arbitration inter-frame space (AIFS) number (AIFSN), and wherein the contend is to be in accordance with the first CWmin, the first CWmax, and the first AIFSN:
assign a second AC to a trigger frame;
encode the trigger frame to comprise resource allocations for stations, the second AC to indicate to the stations a type of data to transmit in the resource allocations; and
when access to the channel is gained with the first AC, configure the wireless device to transmit the trigger frame to the stations, wherein the trigger frame is to start a TXOP with the first TXOP limit.

19. The non-transitory computer-readable storage medium of claim 18, wherein the first AC and the second AC are each one from the following group: AC video, AC voice, AC best effort, AC background, and AC trigger frame.

20. A method performed by a wireless device, the method comprising:
contending for access to a wireless medium of a channel with a first access category (AC), wherein the first AC comprises a first transmission opportunity (TXOP) limit, a first contention window minimum (CWmin), a first contention window maximum (CWmax), and a first arbitration inter-frame space (AIFS) number (AIFSN), and wherein the contend is to be in accordance with the first CWmin, the first CWmax, and the first AIFSN;
assigning a second AC to a trigger frame;
encoding the trigger frame to comprise resource allocations for stations, the second AC to indicate to the stations a type of data to transmit in the resource allocations; and
when access to the channel is gained with the first AC, configuring the wireless device to transmit the trigger frame to the stations, wherein the trigger frame is to start a TXOP with the first TXOP limit.

21. The method of claim 20, wherein the first AC and the second AC are each one from the following group: AC video, AC voice, AC best effort, AC background, and AC trigger frame.

22. An apparatus of a station comprising: memory; and processing circuitry coupled to the memory, the processing circuity configured to:
decode a trigger frame comprising an uplink (UL) resource allocation for the station and an indication of an access category (AC);
select data to transmit based on the AC;
encode a frame comprising the selected data; and
configure the station to transmit the frame in accordance with the UL resource allocation.

23. The apparatus of claim 22, wherein the processing circuitry is further configured to:
select the data with the AC first, and then select data with an AC with a higher priority than the AC.

24. The apparatus of claim 22, further comprising: transceiver circuitry coupled to the processing circuitry.

25. An apparatus of a wireless device comprising: memory; and
processing circuitry coupled to the memory, the processing circuity configured to:
contend for a wireless medium of a channel using an enhanced distributed channel access (EDCA) function (EDCAF);
encode a trigger frame to comprise uplink (UL) resource allocations for stations to transmit UL data to the wireless device, wherein the stations are to be associated with the wireless device; and
when access to the channel is gained with the EDCAF, configure the wireless device to transmit the trigger frame to the stations, wherein the trigger frame is to start a transmission opportunity (TXOP).

26. The apparatus of claim 25, wherein the processing circuitry is further configured to:
contend for the wireless medium of the channel using the EDCAF and additional EDCAFs, wherein one EDCAF is to be used for each station associated with the wireless device.

27. The apparatus of claim 26, wherein the processing circuitry is further configured to:
if two EDCAFs gain access to the wireless medium at a same time, select one of the two EDCAFs based on a priority of download traffic for a corresponding station associated with the wireless device.

28. The apparatus of claim 25, wherein the processing circuitry is further configured to:
contend for the wireless medium of the channel using the EDCAF, wherein the EDCAF is to include multiple counters to contend for the wireless medium.

29. The apparatus of claim 28, wherein the processing circuitry is further configured to:
determine a number of the multiple counters based on a number of active stations associated with the wireless device.

30. The apparatus of claim 25, wherein the processing circuitry is further configured to:
store indications of uplink (UL) data in UL queues for each associated station; and
determine parameters for the EDCAF to contend for the wireless medium based on a number of stations in the UL queues, the parameters comprising one or more of the following group: a contention window minimum, a contention window maximum, and an arbitration inter-frame space (AIFS) number (AIFSN).

31. The apparatus of claim 30, wherein an indication of UL data comprises resource allocation requests from the stations.

32. The apparatus of claim 25, wherein the processing circuitry is further configured to:
contend for the wireless medium of the channel using EDCAF in accordance with EDCA parameters for the stations.

33. The apparatus of claim 25, further comprising: transceiver circuitry coupled to the processing circuitry.
